(19) United States
(12) Patent Application Publication
(10) Pub. No.: US 2005/0086239 A1
(43) Pub. Date: Apr. 21, 2005

(54) System or method for analyzing information organized in a configurable manner

(76) Inventors: Eric Swann, Austin, TX (US); Greg Carter, Austin, TX (US); Paul West, Austin, TX (US); Robert Hogan, Austin, TX (US); Elizabeth Lescher, Austin, TX (US); Jason Oban, Austin, TX (US); Kevin Miller, Austin, TX (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/840,081

(22) Filed: May 6, 2004

Related U.S. Application Data
(63) Continuation-in-part of application No. 09/441,289, filed on Nov. 16, 1999.
(63) Continuation-in-part of application No. 09/503,671, filed on Feb. 14, 2000.
(63) Continuation-in-part of application No. 09/504,000, filed on Feb. 14, 2000.
(63) Continuation-in-part of application No. 09/504,343, filed on Feb. 14, 2000.
(63) Continuation-in-part of application No. 09/653,735, filed on Sep. 1, 2000.
(63) Continuation-in-part of application No. 09/702,363, filed on Oct. 31, 2000.
(63) Continuation-in-part of application No. 09/714,702, filed on Nov. 16, 2000.
(63) Continuation-in-part of application No. 09/995,287, filed on Nov. 26, 2001.
(63) Continuation-in-part of application No. 09/995,374, filed on Nov. 26, 2001.
(60) Provisional application No. 60/166,042, filed on Nov. 17, 1999.
(60) Provisional application No. 60/468,440, filed on May 6, 2003.

(51) Int. Cl. G06F 7/00

(52) U.S. Cl. 707/100

(57) ABSTRACT

A customized and configurable analysis system is disclosed for analyzing data captured from a wide variety of different sources, such as an asset management application. Regardless of the particular embodiment, the analysis system provides users with the ability to modify and customize the underlying data design to enhance the analytical functionality of the analysis system. The modification of the data design occurs through the use of various templates that are part of the user interface for the analysis system. Thus, persons without specialized database and data architect expertise can modify underlying data design in a timely and inexpensive manner.

### RELATED APPLICATIONS

This Continuation-In-Part application. Claims the benefit of the U.S. application Ser. No. 09/441,289 filed Nov. 16, 1999; U.S. Provisional Application Ser. No. 60/166,042 filed Nov. 17, 1999; U.S. application Ser. No. 09/503,671 filed Feb. 14, 2000; U.S. application Ser. No. 09/504,000 filed Feb. 14, 2000; U.S. application Ser. No. 09/504,343 filed Feb. 14, 2000; U.S. application Ser. No. 09/653,735 filed Sep. 1, 2000; U.S. application Ser. No. 09/702,363 filed Oct. 31, 2000; U.S. application Ser. No. 09/714,702 filed Nov. 16, 2000; U.S. application Ser. No. 09/995,287, filed Nov. 26, 2001; U.S. application Ser. No. 09/995,374, filed Nov. 26, 2001; and U.S. Provisional Application Ser. No. 60/468,440, filed on May 6, 2003, the contents of which are all hereby incorporated in their entirety by reference.

### BACKGROUND OF THE INVENTION

The present invention relates in general to systems or methods for analyzing data (collectively “data analysis systems” or simply “analysis systems”). In particular, the present invention relates to highly configurable and customizable analysis systems that provide non-information technology specialists with the capability of modifying the ways in which information is organized.

Access to adequate, relevant, and accurate information in a timely and integrated manner is increasingly necessary for an organization's survival in the 21^{st} century. Organizations seeking to use information in an efficient and effective manner face many obstacles. Many of those obstacles can be placed into one of two general categories. The first category of obstacles is the problem of collection. Effective data analysis requires that the necessary data exist in a way such that it can be stored, processed, and accessed in a timely manner. The second category of obstacles relate to the navigation, parsing, and analysis of the existing pool of data. The second category of obstacles often includes both the problem of finding a “needle in a haystack” as well as the problem of “not seeing the forest for the trees.”

Increasingly inexpensive data capture and storage technologies provide data analysts with an abundance of data that can potentially be “mined” in highly valuable ways. However, the development of tools designed to combat the second category of obstacles has not kept up with the development of data capture and storage technologies. Existing tools do not provide a sufficiently effective way for an organization to mine their data. This lacking is particularly evident in the context of asset management applications, where the technology of capturing data may not be cognizant of how the analytical functionality would desire to analyze the captured data.

One significant obstacle to comprehensive, inexpensive, and timely data analysis is the difficulty in achieving highly granular and customized processing that is tailored specifically to the topic of analysis. A wide variety of analysis systems face common challenges relating to granularity and customization. Highly customized systems are expensive and time consuming to implement, as well as to maintain. One type of analysis system in which customization challenges are particularly evident is in the realm of asset management applications. Different types of assets may focus on entirely different types of data.

Various types of asset management applications or asset inventory management applications (collectively “asset management programs” or “asset management software”) are available to assist organizations in better managing their assets. By more closely tracking asset-related information, organizations can learn how to: maintain assets more efficiently; make better procurement decisions by avoiding the purchase of relatively expensive assets (factoring in post-purchase costs); and better coordinate decisions relating to assets so those decisions can further the overall goals of the organization. Like other embodiments of analysis systems, asset management software can require a wide variety of different data design configurations to support the desired data analysis. Changes to the underlying data design of an application requires changing the underlying database table definitions, which in turn require the services of an information technology specialist, such as a database administrator.

The business realities of software development actively impede the development and implementation of effective asset management solutions because the challenges of better asset management are not conducive to a “one size fits all” software solution. In contrast to less context dependent applications such as word processing, asset management is specific to the type of organization, the type of assets, and the type of events or transactions that relate to the assets and organizations. In short, effective asset management requires a high degree of granularity, which requires a high degree of flexibility and customization. If an asset management application is to successfully automate any type of meaningful analysis, it needs to incorporate the viewpoint and decision making structure of the particular organization or sub-unit of the organization.

Highly customizable software in any context is expensive to implement as well as maintain because the functionality of such software is heavily dependent upon the data design that underlies the particular asset management application. The creation and subsequent updating of the underlying data design requires time intensive activities by highly skilled persons such as database administrators and data architects.

It would be desirable if the data design underlying a particular software application could be modified by a user through the use of the application itself, and not through specialized database management tools. Such changes could be made by persons without any special technical expertise relating to databases and data designs. In such an application, the ways in which data is organized can be changed without changing the database table definitions.

Small organizations could benefit greatly by such functionality because application service providers (“ASPs”) and other vendors could provide small organizations the ability to inexpensively configure and customize applications that would be too expensive to create in-house. Large organizations could also benefit by such technology, because business domain experts could implement fundamental changes to the data design of the analysis system without the time and expense involved in requiring assistance from a database or data design specialist.

The known existing art does not teach or in any way affirmatively suggest the use of a template by non-technical users to customize an asset management application or other form of analysis system, by modification of the underlying data design. The thought of allowing users without any information technology expertise to change the underlying data design of an application runs counter to well established prudent practices in database management. Moreover, the difficult tradeoffs between meaningful customization and robust parameters for constraining undesired user activities affirmatively teach away from the ability of a non-technical user to configure an analysis system through the modification and configuration of the data design used by the particular software applications making up the analysis system.

### SUMMARY OF THE INVENTION

The present invention relates in general to systems or methods for analyzing data (collectively “data analysis systems” or simply “analysis systems”). In particular, the present invention relates to a highly configurable and customizable analysis system that provides non-information technology specialists with the capability of modifying the data design to enhance various analysis functions without needing to implement changes to the database tables and columns.

I. Template Builder

Various application “templates” allow users to modify the data design underlying an application through the application itself, and not a specialized database design or management tool. Thus, data design changes can be made more quickly, less expensively, and without changing the any tables or columns in the database. In a preferred embodiment, the application incorporating the templates is an asset and inventory management application (“AIM” or simply “asset management application”). A wide variety of different application contexts can incorporate an analysis system that utilizes configurable templates to modify the data designs used by those applications without making any changes to the ways in which database columns and tables are defined and implemented in the database.

The template-based approach to modification of the underlying data design is particularly beneficial in contexts involving highly normalized and granular data that involve a significant number of interrelationships. For example, in an application service provider (“ASP”) embodiment of an analysis system interfacing with an asset management application, there are a multitude of different organizations, assets, transactions, business rules, roles, accounting practices, and other distinguishing characteristics required for truly modular and granular processing. The number of potential relationships between these various attributes grows exponentially as the number of attribute records in the database grow.

In some asset management embodiments of the system, an asset subsystem is used to track and process asset attributes, an organization subsystem is used to track and process organization attributes, and a transaction subsystem is used to track and process transaction attributes. By providing users with the ability to easily modify and configure the different relationships between the different types of attributes, the system provides business users with the ability to maximize the possibilities for customization, allowing the analysis system to view data in way that most closely resembles how the organization would find the information to be relevant.

In some asset management embodiments of the system, an asset template is used to define asset attributes, an organization template is used to define organization attributes, and one or more transaction templates are used to define various transaction attributes. In a preferred embodiment, there are three transaction templates, a transaction header template, a transaction body template, and a transaction detail template. Transaction templates can be used to correlate business activities with accounting events.

In some embodiments, the existence of templates with the functionality to modify the underlying data design of a software application can be thought of as an interactive interface layer between the application and the database. Such templates allow the application to change the data design without requiring the modifying user to be cognizant of the physical database table structure, much less possess the knowledge to actually modify the physical database table structure.

II. Query Builder

The user interface for submitting queries, generating reports, and performing searches (collectively “queries”) can possess the degree of granularity and customization that corresponds to the user interface that is used to create the templates. Dynamic reports can thus be created from fields that have been defined through the user interface, freeing the user from limitations that would otherwise be inherent in any type of implementation or setup process. The interface allows users to modify the data design underlying an application through the application itself, and not through a specialized database design or management tool. Thus, data design changes can be made more quickly and less expensively, without changing the definitions of any database tables or columns. Moreover, newly created of modified fields can serve as the basis for new types of analysis and reports. In a preferred embodiment, the application incorporating the templates is an asset and inventory management application (“AIM” or simply “asset management application”). A wide variety of different application contexts can incorporate an analysis system that utilizes configurable templates to modify the underlying data designs used by those applications.

The highly flexible and customizable approach to the configuration of the underlying data design is particularly beneficial in contexts involving highly normalized and granular data involving a significant number of interrelationships. For example, in an application service provider (“ASP”) embodiment of an analysis system interfacing with an asset management application, there are a multitude of different organizations, assets, transactions, business rules, roles, accounting practices, and other distinguishing characteristics required for truly modular and granular processing and reporting. The number of potential relationships between these various attributes grows exponentially as the number of attribute records in the database grow.

In some asset management embodiments of the system, an asset subsystem is used to track and process asset attributes, an organization subsystem is used to track and process organization attributes, and a transaction subsystem is used to track and process transaction attributes. All data can be stored in user-defined database tables and user-defined database fields. Such customizations can then be the basis for report queries, and the automated reports resulting from those queries. By providing users with the ability to modify and configure the different relationships between the different types of attributes, the system provides business users with the ability to maximize the possibilities for customization, allowing the analysis system to view data in way that most closely resembles how the organization would find the information to be relevant.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a process flow diagram illustrating an example of an analysis system allowing a user to interact with the data design through the use of a template and a query.

FIG. 2 is a schematic block diagram illustrating an example of data collection process in an asset management embodiment of the analysis system.

FIG. 3 is a relationship diagram illustrating an example of the different types of data sources that can be incorporated into an asset management embodiment of the analysis system.

FIG. 4 is a flow chart illustrating an example of an asset management embodiment of the analysis system, performing an analysis of asset-related information to determine responsibility for asset utilization, and developing a lease relationship between an asset owner and an asset user based on asset utilization criteria.

FIG. 5 is a flow chart illustrating an example of automated maintenance activities invoked by an asset management embodiment of the analysis system.

FIG. 6 is a flow chart illustrating an example of asset management functionality after a work order is generated based on maintenance approval.

FIG. 7 is a process flow diagram illustrating an example of the data acquisition and analysis functionality that can be performed by an asset management embodiment of the analysis system.

FIGS. 8a-8e are block diagrams illustrating examples of subsystem-level views of the analysis system in an asset management embodiment.

FIG. 9 is a block diagram illustrating the use of a template as a customizable interface between the various attributes that can be tracked and processed by an asset management embodiment of the analysis system, and the automated processing that can result.

FIG. 10 is block diagram illustrating an example of different types of templates that can be incorporated into the analysis system, and some of the processing elements that can be acted upon by those templates.

FIG. 11 is a screen view illustrating an example of an asset entity template screen that can be incorporated into the analysis system.

FIG. 12 is a screen view illustrating an example of an organization entity template screen that can be incorporated into the analysis system.

FIG. 13 is a screen view illustrating an example of a transaction template screen that can be incorporated into the analysis system.

FIG. 14 is a screen view of a template management layout screen that can be incorporated into the analysis system.

FIG. 15 is a screen view of a template management search screen that can be incorporated into the analysis system.

FIG. 16 is a flow chart illustrating an example of a method for using a template to support customized and automated analysis processing.

FIG. 17 is a flow chart illustrating an example of a method for using a template in the context of an asset management embodiment of the analysis system.

FIG. 18 is a screen view illustrating an example of a reports screen for non-entity based reports that can be incorporated into the analysis system.

FIG. 19 is a screen view illustrating an example of a reports screen for entity and transaction based reports that can be incorporated into the analysis system.

FIG. 20 is a screen view illustrating an example of an express builder screen that can be incorporated into the analysis system.

FIG. 21 is a screen view illustrating an example of a reports list screen that can be incorporated into the analysis system.

FIG. 22 is a flow chart illustrating an example of a method for customizing reports.

FIG. 23 is a flow chart illustrating an example of a method for creating highly customized reports in the context of an asset management embodiment of the analysis system.

FIG. 24 is a diagram illustrating the relationships between FIGS. 24a-h.

FIGS. 24a-h are portions of a database diagram illustrating an example of a database table design that can support highly customized report management for non-technical information technology users.

### DETAILED DESCRIPTION

The present invention relates in general to systems or methods for analyzing data (collectively “data analysis systems” or simply “analysis systems”). In particular, the present invention relates to a highly configurable and customizable analysis system that provides non-information technology specialists with the capability of modifying the underlying data design (without changing the design of the database tables) to enhance various analysis functions.

I. Introduction of Elements

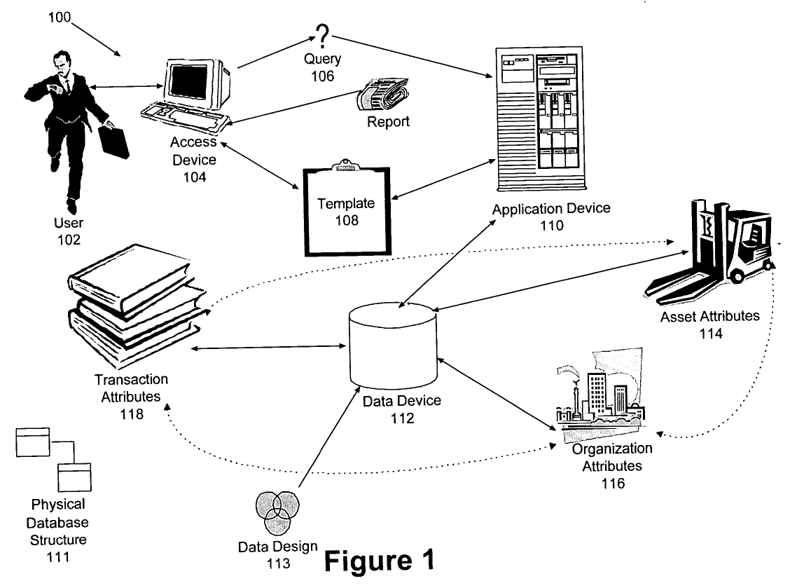

FIG. 1 is a process flow diagram illustrating an example of an data analysis system (“analysis system” or simply “system”) 100 allowing a user 102 to manipulate a data design 113 in order to facilitate greater granularity in performing the analysis. The analysis system 100 can be used to analyze virtually any type of data, including both quantitative and qualitative information. The analysis system 100 can assist an organization in navigating, organizing, and otherwise harvesting value from the potentially vast libraries of the data maintained by the organization. In some embodiments, the system 100 is utilized by an asset and inventory management application (“asset management application”) to allow organizations to make better decisions regarding their assets by providing an analysis relating to relevant decision-making factors. In alternative embodiments, a wide variety of different contexts can benefit from interfacing with the analysis system 100. Banks could use the analysis system 100 to analyze different types of loans. Real estate brokers could use the analysis system 100 to analyze the cost-benefit analysis of certain types of real estate transactions. Sports teams could use the analysis system 100 to determine desirable player acquisitions or trades. The number of different uses for the analysis system 100 is limited only by the potential number of goals that a user 102 can have with respect to analyzing information.

A. User

The user 102 is potentially any person or entity that can request that an analysis be performed by the system 100. In many embodiments, the user 102 is a human being affiliated with some type of organization. However, users 102 can also be various forms of automated intelligence, such as neural networks, artificial intelligence, expert systems, and automated agents. If the user 102 is a person, that person need not possess information technology expertise relating to database administration or data architecture. A user 102 without such expertise can use one or more templates 108 to interact directly with the data design 113, modifying or expanding upon the data design 113 as desired (without modifying an a database structure 111)). The system 100 is highly customizable and configurable by a wide range of users 102, so long as those users 102 are duly authorized to engage in such activities.

B. Access Device

An access device 104 is potentially any device that allows the user 102 to interact with the system 100 by interacting with the user interface of the application(s) housed in an application device 110. In a preferred embodiment of the system 100, the access device 104 is some type of computer or communications device with an Internet browser. Such devices can include handheld devices such as personal digital assistants, cell phones, wireless pagers, laptops with wireless modems, and other similarly portable devices. Access devices an also include more traditional computer laptop, desktop, mini-computer, super-computer, and mainframe environments.

C. User Interface

A user interface is what connects the activities of the user 102 interacting with the access device 104 to the application housed in the application device 110. In a preferred embodiment of the system 100, the user interface is a web site. The user interface can be broken down in various components that perform specific tasks. The templates 108 used to modify the data design 113 are one example of such user interface components. Additional examples include a query 106 and a report 107. Queries 106 can be sent to the application in order to generate a corresponding report 107.

1. Templates

In a preferred embodiment of the system 100, one or more templates 108 are used to interact with, modify, and further define the data design 113 used by the system 100 to support the various analysis functions. In a preferred embodiment, templates 108 can be used by users 102 to organize information into various hierarchical trees. For example, in an asset management embodiment, one type of template can be an asset template, with one branch on the “tree” representing industrial equipment, with subsequent branches representing forklifts and large battery powered forklifts, respectfully. Templates 108 can take a wide variety of different forms (including non-hierarchical and non-graphical forms) while still allowing for interactions with the data design 113 used by the applications of the system 100. However, to facilitate the ability of business users 102 possession little or no information technology expertise, graphical hierarchy trees can be preferable to other interface approaches. In a preferred embodiment of the system 100, online analytical processing (“OLAP”) functionality is supported by the system 100 using templates 108. Versatility in the templates 108 used by the system 100 can be helpful in making the user interface for data design 113 modifications as user friendly as possible. Template 108 functionality is described in greater detail below.

2. Query

Templates 108 are used to define or modify the data design 113 used by a particular application interfacing with or connect to the system 100. The data design 113 as then defined can be populated with data that is useful for the purposes of conducting an analysis. An analysis can be invoked by the creation and submission of a query 106. In a preferred embodiment, all of the nuances in the highly normalized and highly granular data design 113 can be used in the construction of the query 106. Queries 106 involve the searching of the data accessible to the analysis system 100 based on the criteria of the query 106. Queries 106 can also involve more than merely searching for particular data. An analysis can also be automatically invoked on the basis of the query 106. For example, the user 102 of an asset management embodiment of the system 100 could query 106 the system 100 for the average annual maintenance costs associated with forklifts that are over 10 years in age. Just as templates 108 can support OLAP processing, queries 106 can also support or result in OLAP processing. Responses to queries 106 can take on many different forms, but each of the various forms can be called a report 107. Query 106 building and process is described in greater detail below.

3. Report

The form and format of a report 107 can vary widely from embodiment to embodiment, as well as from query 106 to query 106 depending on how users 102 have customized and configured the system 100. A report 107 can consist merely of a single analysis value resulting from a query 106. For example, a query 106 requesting the number of jet planes exceeding 50 years in age could result in a response of zero. A more complex query 106 will typically result in a more complex report 107. For example, a query 106 relating to the expected maintenance costs for an entire line of machinery could result in'the display of various graphs and the performance of various statistical calculations in determining such analysis values based on various criteria. The system 100 can support OLAP processing in the generating of reports.

In certain embodiments of the system 100 such as an asset management embodiment, reports 107 can involve more than simply the transmission of information. A report 107 can also invoke automated feedback in different ways. For example, if a report 107 indicates that a particular machine would be unsafe to use without immediate maintenance, the system 100 could preclude the use of that machine until maintenance work is performed and recorded in the system 100. Other responses could include automated e-mails suggestion an oil change or reminding a particular asset user that he or she needs to undergo training in order to use a certain asset in a certain way. Reports can include the results of any data mining performed by the system 100. Reports 107 are described in greater detail below.

D. Application and Application Device

An application device 110 is any device capable of housing the analysis applications that allow the analysis system 100 to analyze data and configure the data design 113. In a preferred embodiment, the application device 110 is a web server hosted by an application service provider (“ASP”). In alternative embodiments, the application device 110 may be a wide variety of different servers or non-server devices configured to connect with access devices 104 in a wide variety of different ways. In some embodiments of the system 100, the access device 104 and the application device 110 may be the same device.

In an ASP embodiment of the system 100, customers of the ASP pay the ASP for the right to access the software applications housed in the application device 110, and such use of the system 100 is controlled by an application service provider agreement. In such embodiments, multiple organizations can interact with the application and the application device 110 in a simultaneous or substantially simultaneous manner.

The application(s) housed in the application device 110 provide users 102 with the ability to automate the data analysis process, and to modify the data design 113 underlying the various analysis applications.

E. Data Device

A data device 112 can be any information technology component used to store information. In a preferred embodiment, the data device 112 is a relational database. In alternative embodiments, object-oriented and other database structures can be used. The data device 112 need not be a database, with various file hierarchies, data structures (such as arrays), and/or other elements can be used to provide essentially the same functionality. The data device 112 is looked at differently by different types of users. From an information technology perspective, the data device 112 houses a physical database structure 111 that is the physical embodiment of the data design 113 used to facilitate the analytical functionality of the system 100. From a business information perspective, the data device 112 houses the various types of information that are useful to the user 102. In an asset management embodiment, information such as asset attributes 114, organization attributes 116, and transaction attributes 118 are stored in the data device.

F. Data Design and Physical Database Structure

A data design 113 or data model is the aggregation of all of the logical relationships that are embodied in the physical database structure 111. For example, if each forklift asset needs to have lifting capacity, that required relationship can be said to exist within the data design. The “physical” database structure 111 is made up of tables and columns as defined by the database schema. The “physical” database structure 111 should be designed to provide the corresponding flexibility required by users 102 with respect to the data design 113. In some embodiments of the system 100, a user 102 can modify the data design 113 without changing the physical database structure 111. In a preferred embodiment, changes to the data design 113 automatically result in a corresponding change to the physical database structure 111. In some embodiments, the modifications made by users 102 with respect to the data design 113 are only implemented in analysis database tables that are distinct from the database tables used to capture the data in the first place.

G. Attributes, Attribute Types, and Attribute Values

Information can generally be referred to as an attribute. Information relating to an asset can be referred to as an asset attribute 114, while information relating to an organization can be referred to as an organization attribute 116. Similarly, information relating to a transaction can be referred to as a transaction attribute 118. An example of an asset attribute could be the type of asset, the monetary value of the asset, the manufacturer of the asset, or any other characteristic of information describing the asset. An attribute can include both attribute types and attribute values. The color of a machine can be an asset attribute type, while blue can be a corresponding attribute value. The name of a transaction can be a transaction attribute type, with the corresponding attribute value being that of a sale. Examples of attribute types and attribute values are discussed in greater detail below.

II. Asset Management Embodiments

As discussed above, the analysis system 100 can be used in conjunction with a wide variety of different applications. However, certain contexts are particularly ripe for use with a highly configurable and customizable analysis system 100. Asset management applications are an example of such a context where analysis can be conducted at very abstract aggregated levels in a simultaneous or substantially simultaneous manner with highly normalized granular analyses.

A. Data Collection

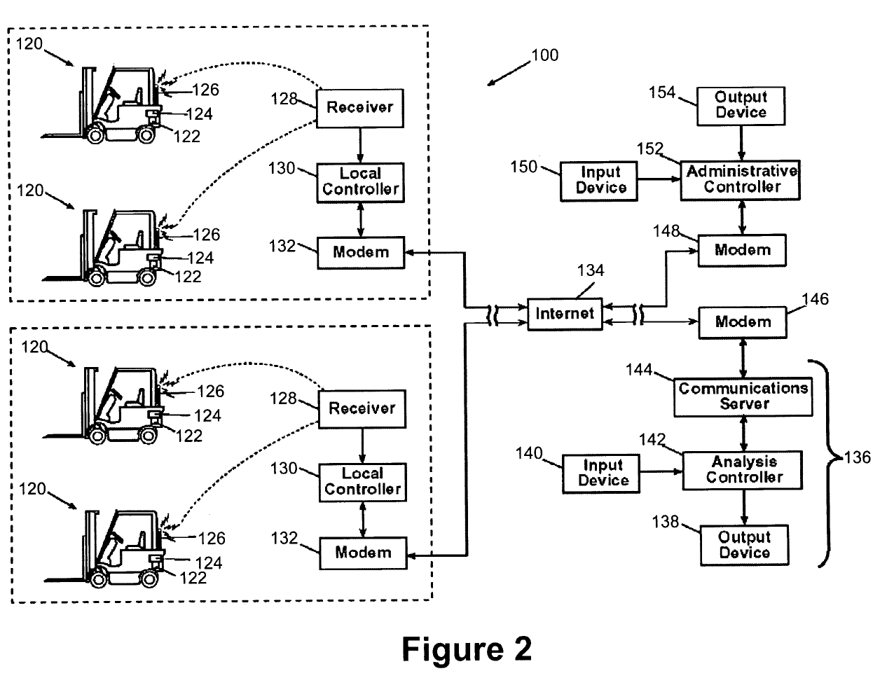

FIG. 2 is a schematic block diagram illustrating an example of data collection in an asset management embodiment of the analysis system 100. The system 100 tracks various assets 120. In the disclosed example, the assets 120 are forklifts, but a wide variety of different assets 120 could be tracked, processed, and analyzed by the system 100. The manufacture of goods or even the performance of services could be tracked as assets 120 by the system 100.

A data acquisition device 122 is provided on each of the forklifts 120 for sensing and storing one or more operating characteristics of the associated forklift 120. The basic structure and operation of each of the data acquisition devices 122 are conventional in the art. For example, each of the data acquisition devices 122 may be embodied as an electronic processor or controller that can sense or be otherwise responsive to one or more operating conditions of the associated forklift 120. Each of the data acquisition devices 122 can be responsive to any desired operating conditions of the forklift 120 that might be considered important in making effective management decisions regarding the operation of the forklift 120. Such desired operating conditions can, for example, include the time duration of use (and non-use), distances traveled, the extent of fork usage, the nature of hydraulic system utilization, and the like. More typically for industrial assets, the most important criteria is time duration of use. The sensed operating conditions of the forklifts 120 are preferably stored at least temporarily in a memory of the data acquisition device 122 for subsequent communication to analysis components, indicated generally at 136, for analysis in the manner described in detail below. Thus, the data acquisition devices 122 sense and store the desired operating conditions for each of the forklifts 120 during use.

Each of the assets 120 can be further provided with a transmitter 124 or other communications component for transmitting the acquired data from the data acquisition device 122 to the remote analysis components 136 for analysis. Each of the transmitters 124 may be embodied as any conventional device for transmitting the acquired data to the remote analysis components 136, such as a hard-wired communications interface. However, as is well known, each of the forklifts 120 is a movable vehicle that is capable of traveling extensively throughout the particular environment in which it is used. To facilitate the transmission of the acquired data, therefore, the transmitter 124 is preferably embodied as a wireless communications component, such as represented by an antenna 126. The transmitters 124 and the wireless communications component 126 can be embodied as conventional radio frequency transmitters provided on each of the forklifts 120 that transmit electromagnetic signals. However, other well known forms of wireless communication, such as those utilizing light or sound, may be used in lieu of a radio frequency transmitter.

The wireless communications components 126 are adapted to transmit signals that are representative of the sensed operating conditions of the forklifts 120 through space to a receiver 128. In contrast to the forklifts 120 that can travel extensively throughout the environment in which they are operated, the receiver 128 is preferably provided at a fixed location within that environment. If desired, a plurality of such receivers 128 may be provided at different locations within the environment in which the forklifts 120 are operated. As the forklifts 120 move about the environment during use, they will occasionally pass by or near the receiver 128. When this occurs, the receiver 128 receives the data transmitted from the respective data acquisition units 122. The receiver 128 is also conventional in the art.

Preferably, the data acquisition units 122 and the receivers 128 are in bi-directional communication with one another. One advantage of such bi-directional communication is that the data acquisition unit 122 can send out a query signal on a predetermined basis to be received by the receiver 128 when the two units 122 and 128 are sufficiently close to communicate reliably with one another. Thus, when the data acquisition unit 122 contacts the receiver 128, the receiver 128 can send a first signal back to the data acquisition unit 122 to instruct it to begin transmitting the acquired data. At the completion of the data transfer, the receiver 128 can send a second signal back to the data acquisition unit 122 to acknowledge the receipt of the transmitted data. A conventional error checking algorithm can be used to confirm the accuracy and completeness of the transmitted data and, if necessary, request a re-transmission thereof.

Another advantage of such bi-directional communication is that data in the form of new commands, program updates, instructions, and the like can be sent to the data acquisition units 122 from the receiver 128. In some instances, such as when a data acquisition unit 122 is in generally continuous communication with a receiver 128, a user of the forklift 120 can be prompted to provide certain information for transmission to the receiver 128 for further analysis.

The receiver 128 is connected to a local controller 130. The local controller 130 is also, of itself, conventional in the art and may be embodied as an electronic controller that is adapted to receive and store at least temporarily the data from each of the receivers 128. Alternatively, if the assets 120 are fixed in position, such as in the case of a plurality of stationary machines used in a manufacturing environment, the receiver 128 or receivers 128 may be provided on movable structures that move about the environment to receive the transmitted information. In either event, it is desirable that the local controller 130 acknowledge receipt of the information transmitted from the data acquisition devices 122, allowing the data acquisition devices 122 to delete the transmitted information and begin storing newly acquired information. A combined system including the data acquisition device 122, the transmitter 124, the wireless communications component 126, the receiver 128, and software for operating the local controller 130 to gather and report data is commercially available, such as from I.D. Systems, Inc. of Hackensack, N.J. or Requip (formerly SXI).

In a preferred embodiment, the various elements located in an asset 120 are hardwired into the electrical system of the asset to minimize the possibility of undesirable failure or tampering.

Thus, after the forklifts 120 have been operated for a period of time, the local controller 130 will have gathered and stored therein a certain amount of information regarding the individual operating characteristics for each of the forklifts 120. The local controller 130 is programmed to periodically transmit the information stored therein to the remote analysis components 136 for analysis. This can be accomplished by providing the local controller 130 with a conventional modem 132 or other communications device that can convert the stored information into a format that is compatible for transmission through an electronic communications network, such as the internet 134. As is well known, the Internet 134 is a digital electronic communications network that connects computer networks and organizational computer facilities around the world. Access to the Internet 134 can be easily obtained in most locations through the local telephone lines or by similar means.

The system 100 may be used to track and manage a plurality of assets 120 located at any desired physical location. Additionally, the system 100 of this invention may be used to track and manage assets 120 located at a plurality of different physical locations, as suggested by the dotted lines in FIG. 2. Each different physical location can be provided with one or more receiver 128, a local controller 130, and a modem 132 to connect the system 100 to the Internet 134.

As mentioned above, the sensed operating conditions of the forklifts 120 are intended to be transmitted to the remote analysis components 50 for analysis. Referring again to FIG. 2, it can be seen that the remote analysis components 136 includes an analysis controller 142 that is connected to communicate through the Internet 134 by means of a modem 52 or similar communications device. If desired, a communications server 144 may be connected between the analysis controller 142 and the modem 52. The communications server 144 is provided to selectively receive and organize the information from each of the local controllers 130 for delivery to the analysis controller 142. The analysis controller 142 can be embodied as any conventional electronic controller that is capable of receiving the sensed operating conditions of the forklifts 120 and for processing that information in a desired manner described in detail below. Ideally, the sensed operating conditions of the forklifts 120 are used to automatically generate and analyze management reports relating to the procurement and utilization of a plurality of the forklifts 120 to maximize productivity and to reduce operating costs and administrative burdens. An input device 140 and an output device 138, both of which are conventional in the art, may be connected to the analysis controller 136.

One or more administrative controllers 152 (only one is illustrated) can be connected to the Internet 134 through respective modems 148 or similar communications devices. Each of the administrative controllers 152 can also be embodied as any conventional electronic controller that can request and receive information from the remote analysis components 136 through the Internet 134. In a manner that is described in detail below, the administrative controllers 152 are provided to request and receive the management information generated by the remote analysis components 136. If desired, the local controller 130 can also function as an administrative controller 152, although such is not necessary. An input device 150 and an output device 154, both of which are conventional in the art, may be connected to the administrative controller 152.

B. Relationships between Organizations

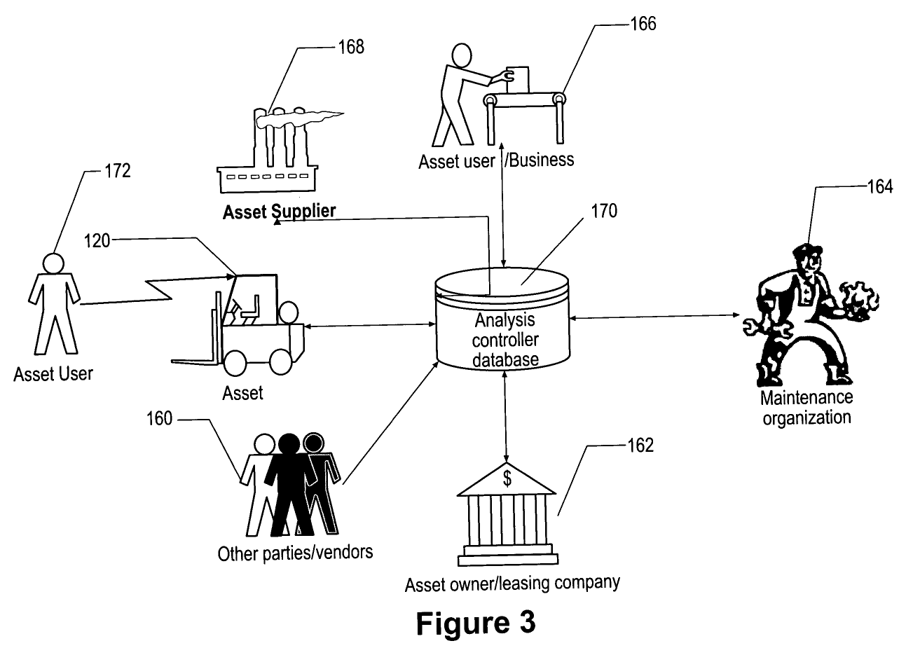

FIG. 3 is a relationship diagram illustrating an example of the different types of data sources that can be incorporated into an asset management embodiment of the analysis system 100.

There are a number of significant advantages to having appropriate access to and the ability to analyze data associated with an asset 120 and the interaction of various parties with regards to information describing that asset. FIG. 3 illustrates the beneficial interrelationships that promote efficiency by having the various parties associated in some way with an asset 120 in one or two-way communication with analysis controller 142 either by way of administrative controller 152, reports 107, web site postings electronic mail, or the like. As illustrated, a maintenance organization 164, an asset manufacturer or supplier 168, asset user/business 166, and asset owner/leasing company 162 all at least provide information to analysis controller database 170 of the analysis controller 142. Both an individual asset user 172 and the asset 120 itself also provide data as illustrated in the figure and discussed herein. Therefore, at the very least each party is required to contribute pertinent information concerning its interaction with an asset 120 to the database 170 of asset controller 142, where the information is available for further consideration and analysis.

As already discussed above, asset 120 provides usage and performance data that is stored in asset controller 142 according to certain predetermined criteria important for that asset including such things as asset location, model, age, usage, and maintenance status. Once relevant data is collected, it is possible to analyze utilization of a specific asset 120. It is also possible to analyze a class of assets 120 using one or more types of available data. From such an analysis, best mode practices can be developed with respect to asset utilization including preventative maintenance and a determination of the extent of optimum asset use. More specifically, for example, a business 166 may decide to standardize its fleet of assets, replace specific assets that have demonstrated unreliability, and either upsize or downsize a fleet to maximize safe asset utilization.

Utilization of asset 120 by an individual asset user 172 is also tracked. A review of the available data can also provide detailed information on the interaction of a business 166 or individual asset users 172 with assets 120 as opposed to other businesses or users. From such an analysis it is possible to consider training issues, certification, and issues related to particular individuals, whose actions can have significantly influence asset utilization.

The role of other vendors such as part distributors, an example of another vendor 160, and maintenance organizations 164 can be compared with respect to other parties in similar roles or historical data to determine their effectiveness. While business 166 may provide its own maintenance of assets 120, a separate maintenance organization 164 is in the illustrated embodiment.

Business relationships can be created such that any party may be penalized or rewarded depending on the results of its activities, providing increased incentives to promote efficiencies. With respect to asset manufacturers or suppliers 168, it is possible to compare assets provided by different suppliers 168 to determine how well their assets perform in practice. Thus, warranty issues, maintenance costs, lost operation time, and the like can be determined from an analysis of asset information over time or involving different manufacturers to provide guidance on how assets 120 from a particular manufacturer perform in different environments and as compared to competing assets of other manufacturers or suppliers in that environment.

More specifically, for an asset manufacturer or supplier 168, warranty information can be of particular interest. While it may not be appropriate for a supplier 178 to be able to alter information in database 170, the ability to quickly and accurately collect information concerning warranty obligations and the like is of particular benefit to all of the parties. For example, warranty issues may be caught more quickly, ultimately reducing asset cost and operation while simultaneously promoting asset up time.

C. Organization Interactions

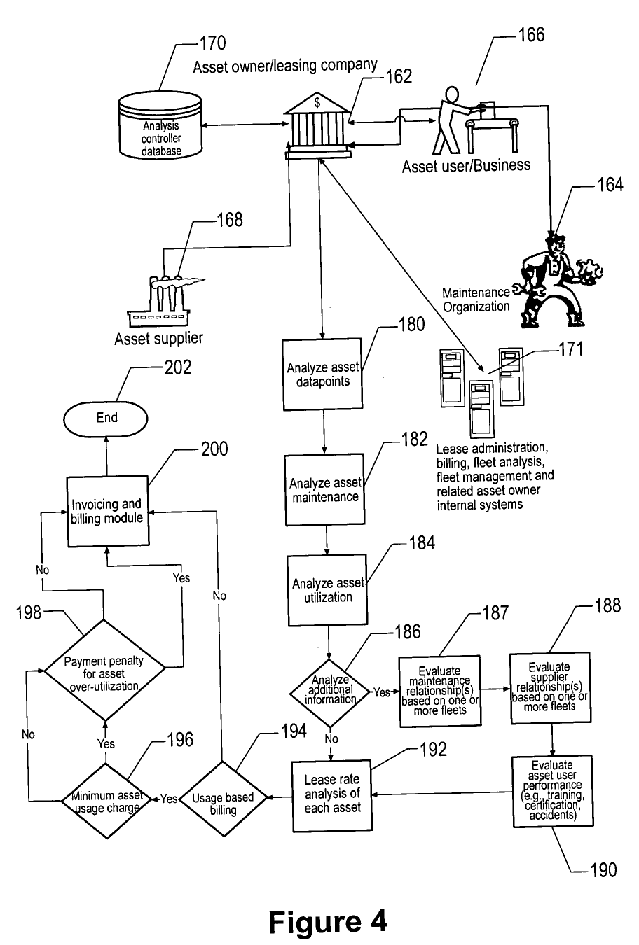

The advantages of an asset owner 162 having at least one and possibly two-way access to the real-time and historical information stored in analysis controller database 170 as well as the ability to communicate with suppliers 168, maintenance organizations 164, and asset using businesses 166, is illustrated in subsystem 98 illustrated in FIG. 4 It is assumed for the discussion that follows that the owner of the asset 120 is a separate asset owner 162 such as a leasing company, as opposed to business 166 itself, although this is not a requirement of the asset management application, is often activated by the asset owner 162 using data from database 170, but typically utilizing its own lease administration and billing systems. In many cases it is also using its own fleet analysis and management systems, which are typically aggregating information from a number of different fleets associated with a plurality of businesses 166. These various systems, one or more of which may be used independently or in concert, are collectively shown at point 171. As noted above, web-site access, generated reports, analysis controllers 142, and administrative controllers 152 provide exemplary access points for pulling asset information from system 100.

An asset owner 162 and an asset user such as business 166 share the common interest in maximizing efficiency by taking into account such variables as asset usage and asset costs. The more information that is available, the more likely that efficiency is maximized. In traditional leasing relationships involving non-fixed or movable assets such as forklifts where minimal asset utilization information is available, the burden of determining the point of maximum efficiency typically rests with business 90, since it has control over the asset. Therefore, a leasing company 162 typically enters into a lease arrangement where a fixed lease amount is paid in periodic payments by business 166 over the life of the lease. At best, only minor flexibilities are provided. When leasing company 162 regains control of an asset 120 at the end of the lease term, there is uncertainty concerning the condition of the asset. This uncertainty also typically rests with business 166 in the form of a financial cushion incorporated into the leasing relationship.

However, such uncertainty is minimized in the present invention. As shown at point 180, asset owner 162 is able to analyze the various desired objectively generated asset data points associated with an asset 120. As noted above, these data points can include the time of asset usage within a fixed time period, distance traveled, and certain performance parameters associated with the particular asset (e.g., hydraulic system usage or fork usage for fork lifts). As noted above, in practice, for industrial assets the time of use is the most important single data point. Then, as shown at point 182, asset owner 162 may analyze maintenance considerations. For example, a major routine overhaul as compared to a system failure can be analyzed. Then at point 184, the asset owner 162 can compare the raw data from the asset with maintenance conducted during the same time period. By comparing the raw data with maintenance considerations, the owner is able to analyze the asset utilization under the control of business 166 if the maintenance organization 164 and supplier 168 are different third parties. For example, the asset owner 162 can determine that an asset 120 has been used very little during the time period, even allowing for maintenance. Alternatively, the owner 162 may determine that the asset 120 is being used continuously when not undergoing maintenance, possibly suggesting that additional assets may be appropriate to reduce overall maintenance stress on the preexisting asset.

Additional information can be analyzed by the asset owner 162 as shown at decision point 186. Typically, the information includes data associated with other parties having access to database 170. As shown at point 187, for example, the asset owner 162 can evaluate the maintenance relationship with maintenance organization 164. If the relationship has been very positive, an appropriate incentive may be provided to the organization in the form of shared cost savings. Alternatively, if the relationship has been negative, an appropriate penalty may also be implemented. The same considerations are available if business 166 acts as its own maintenance organization 164.

Similarly, the asset owner 162 may evaluate its relationship with the asset supplier 168 as shown at point 188. The information may affect asset payments from the owner to the supplier or the future relationship of the parties.

A further evaluation, shown at point 190, may include an analysis of individual asset users 172 themselves associated with a specific business 166 and their interaction with particular assets 120 or classes of assets, and such things as training level, certification, accident rates, and the like.

One of the useful advantages of the present invention is the ability to take data concerning any asset 120 and the interaction with that asset by any party, including the asset user 172, maintenance organization 164, asset manufacturer or supplier 168, business 166, asset owner 162, or other parties/vendors 160. Moreover, groups of assets 120 may be combined. Thus, it is possible to analyze data to identify the cost of owning or using any asset 120 and the productivity of that asset 120. Moreover, based on an adequately large statistical universe of data it is possible to benchmark asset utilization and cost against others in similar circumstances to identify best practices. Thus, it is possible to efficiency can be maximized while simultaneously minimizing unwanted waste by identifying time and cost saving opportunities. It is also possible to determine those parties providing best practice services with respect to asset utilization (e.g., maintenance) so that their services can be expanded and appropriate recognition given for their efforts. Alternatively, it is possible to identify parties providing unacceptable services so that appropriate remedial action may be taken (e.g., the asset user 172 has inadequate training to properly use an asset so additional training needs to be provided). The ability of the system 100 to perform benchmarking, data mining, and other forms of analysis is described in greater detail below.

In practice, the present invention provides a business 166 with a report screen showing information regarding the fleet associated with that business. Business 166 compares its current fleet information with its own historical information or pertinent information from unnamed companies in the same general industry. A side-by-side comparison will be provided, thereby providing a business 166 or the asset owner 162 with guidance on how to improve fleet utilization using the best practices comparison.

These various advantages are applicable even if asset owner 162 and business 166 are the same entity. However, more typically with industrial equipment, asset owner 162 is different than asset user 172, where the two parties have entered into a lessor/lessee relationship. In such a case, the information in database 170 may be used to mutually maximize the relationship between the asset owner 162 and the business 166. With appropriate safeguards asset owner 162 may be willing to share in a greater portion of the risk associated with the utilization of asset 120 in determining a lease rate based on an analysis of each user fleet or individual asset as shown at point 192. Most significantly, rather than entering into a traditional fixed lease amount as noted above, asset owner 162 may be willing to enter into a hybrid lease arrangement wherein the lease charge may be a combination of one or more of the following elements: 1) a minimum payment that has to be made if asset utilization is below a pre-determined minimum threshold; 2) a usage based-payment that is made if usage is above the pre-determined minimum threshold and below a pre-determined maximum threshold; 3) a penalty payment or surcharge is made if utilization is higher than the pre-determined maximum threshold; and 4) payments/rewards based on incentive issues such as asset re-allocation or timely maintenance.

The decision of whether to use usage-based billing based on one or more objective criteria based on an analysis of asset utilization is shown at decision point 194. The decisions to charge either a minimum payment if a certain usage level is not met, or to charge a usage penalty above a maximum appropriate usage level, are shown by decision points 194 and 196 respectively. Thus, a variable-amount lease may be developed based on an analysis of objective criteria that is based in large part on the actual portion of an asset's life that is consumed by the asset user (e.g., usage hours). In a preferred embodiment, the analysis is based on a pre-determined usage/pricing matrix in combination with actual usage for a specified time period. Once a level of maximum efficiency has developed, leasing will typically be primarily, if not solely, based on asset usage billing.

Through the use of the innovative leasing arrangement based on improved information availability to asset owner 92, the expenses of an asset user such as business 90 can be more accurately aligned with usage and asset value consumption. More operational flexibility is provided to business 90. When leasing is based predominantly on asset usage billing, a business 90 is able to adopt true off-balance sheet financing (i.e., the business is not required to note a financial obligation even in the footnotes of various financial reports as opposed to standard off-balance sheet leasing where a company must disclose the lease in footnotes even if the lease does not show up on the balance sheet). At the same time, asset owner 92, can collect information from a variety of sources to maximize its relationships with its own vendors and customers to the benefit of all related parties by minimizing inefficiencies and providing appropriate accountability with maximum accuracy and validity tied to a minimal likelihood for mistakes, misinformation, or even fraud.

These various factors can be adjusted dynamically by the asset owner 92 as a knowledge base is collected within its internal systems 99 and based on the actions of the other related parties. For a sophisticated asset owner with numerous fleets, it can conduct appropriate analyses over all of its fleets to determine certain trends, which it may advantageously use.

For example, if supplier 88 or maintenance organization 86 is responsible for abnormally low asset utilization as opposed to actions within the control of business 90, then the risk associated with these possibilities can be shared between asset owner 92 and various affected businesses 90 and transferred in some fashion to the responsible party. Thus, in a more preferred embodiment of the invention, asset usage is adjusted for maintenance considerations if business 90 is not responsible for its own maintenance.

As shown at point 120, once the readily available information is analyzed in view of the business relationship between an asset owner 92 and a business 90, an invoice and billing module associated with the asset owner's own internal systems 99 is invoked that generates an appropriate invoice that is sent by the asset owner to the business for payment and subsystem 98 terminates at point 122. In a preferred embodiment, once subsystem 98 is developed for a particular situation, and in the absence of an extraordinary event, invoicing is automated based strictly on the objective criteria developed with minimal outside involvement.

A key advantage of the present invention is that real-time data is collected by data acquisition device 34 and timely transmitted to local controller 130 for transmission to database 78 of analysis controller 142. If incomplete or limited data representing only a small portion of the appropriate asset data points are transmitted, then appropriate decisions cannot be made to maximize asset utilization. For example, in the case of forklifts, both time of usage and distance traveled help provide information concerning asset utilization and maintenance considerations.

Thus, the computer based system 30, including subsystem 98, of the present invention provides a superior method for tracking and managing the assets 120 than the prior art system 10. First, by providing the assets with the data acquisition devices 32 and the communications system 33 and 34, the operational characteristics and other information regarding the assets 120 is automatically sensed and transmitted to the analysis controller 142 on a real time basis, without requiring human intervention or assistance. Second, the analysis controller 142 is programmed to analyze such information as it is received and to automatically generate maintenance and warranty reports in response thereto. Third, all of the reports generated by the analysis controller 142 are automatically delivered to the appropriate persons through the Internet 134, either directly to one or more of the administrative controllers 55 or by posting on a web site, electronic mail or similar mechanisms. Fourth, as shown by subsystem 98, the information can be used to maximize asset usage efficiency. As a result, the computer based system 30 facilitates the gathering, analyzing, and delivering of information relating to the procurement and utilization of the assets 120 so as to maximize productivity and to reduce operating costs and administrative burdens to the benefit of all parties having a relationship with the asset and an interest in its performance.

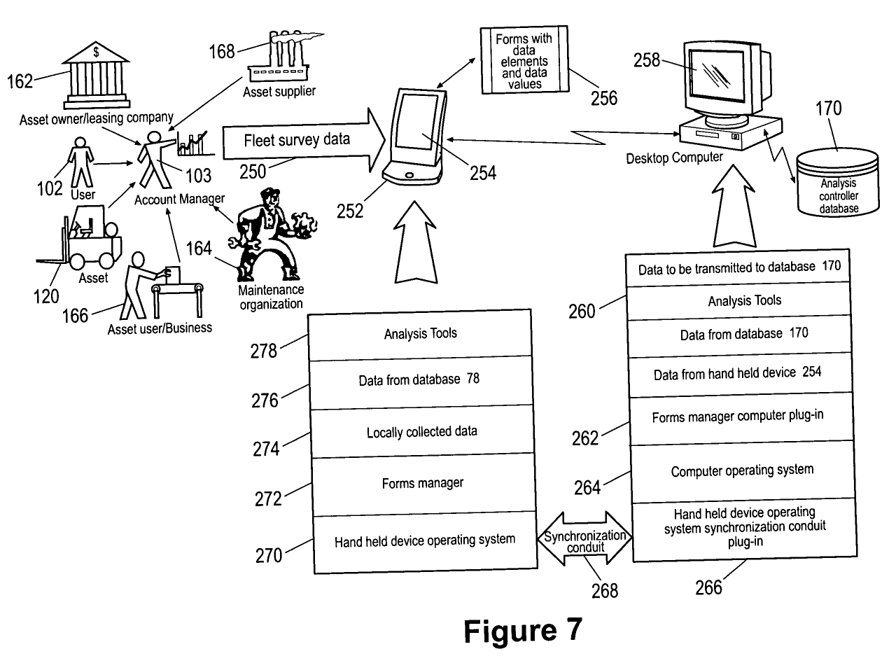

The providing of maintenance to an asset 120 is illustrated in further detail in FIG. 7. In addition to determining whether it is necessary to provide scheduled maintenance as noted at step 65 of FIG. 4A, changes in operational parameters associated with asset 120 as shown at point 150 may result in the generation of a specific fault code if a maintenance problem is detected that requires a more expeditious response. The fault code may be generated by the asset itself using one or more sensors associated with operational parameters of asset 120 as shown by point 152 and communicated to the data acquisition device 32. In addition, analysis controller 142 may analyze the raw operational data received from the asset 120 and compare it with analysis controller database 78 including the history of the specific asset 120 as well as the history of similar assets from which maintenance trends may be determined as discussed with respect to FIG. 4C above. Based on an analysis of such trends, proactive lower cost maintenance can be performed in a timely manner to avoid higher maintenance costs at a later date.

A fault code may even be generated based on the actions of the asset operator. In a preferred embodiment of the invention, an electronic checklist 154 is completed by the asset operator on a regular basis, which may include information concerning asset performance that is more detailed than that available from a review of raw operational parameters. In accordance with OSHA requirements, for example, at the end of each shift, a forklift operator must complete a checklist concerning the performance of the asset during the shift. Some of the questions associated with checklist 154 are directed to maintenance issues. Therefore, in a preferred embodiment of the invention, checklist 154 would be completed electronically at the asset 120, and transmitted by way of the data acquisition device 32 to analysis controller 142 as discussed above. The information would be analyzed to determine if an OSHA/repair need is identified. Preferably, the analysis is automated in accordance with a comparison of the operational status with pre-determined rules. For example, if a question asks if there is a hydraulic leak for a forklift and the answer is “yes”, then maintenance would be appropriate.

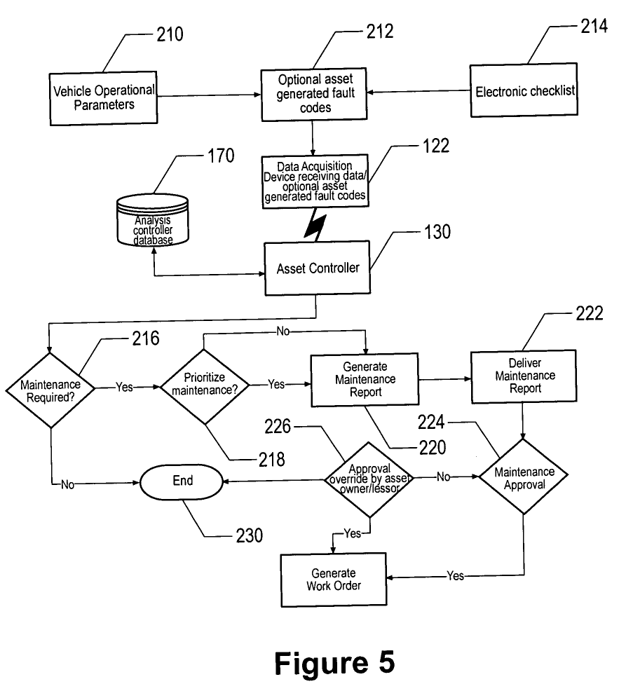

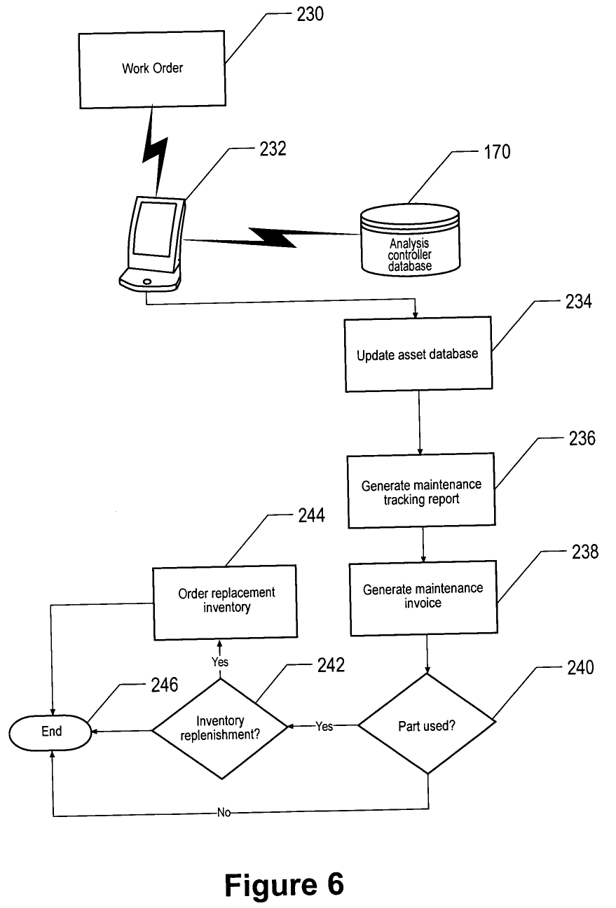

Once it is determined that maintenance of some type is required as shown at point 156 based on an analysis of the operational status of asset 120, a maintenance report 66 is generated as also shown in FIG. 4A and made available electronically at point 67′ such as by the Internet or by posting on a website as also shown in FIG. 4A. The use of electronic mail, or the providing of real-time access to the raw data stored within database 78 by the maintenance organization 86, shown in FIG. 5, is also possible to generate the maintenance report 66. An advantage of providing a maintenance organization 86 real-time access to the raw data representing the operational status of asset 120 is that it may develop specialized analysis tools based on its own expertise in maintenance, resulting for example in the creation of specialized rules for use in automatically analyzing raw data in determining whether maintenance is required, minimizing the need for manual review and determination.

In a preferred embodiment, the priority of the proposed maintenance required 158 is noted on the maintenance report. For example, critical maintenance issues should take precedence over routine issues. Moreover, the system generally institutes an approval process as shown at point 160. For example, if the proposed maintenance is related to warranty work such as noted with respect to step 69 of FIG. 4B, the manufacturer or supplier should approve the maintenance. If a lessee is responsible for the proposed maintenance, it should approve the maintenance before it is performed. In some cases, the maintenance organization 86 itself approves the maintenance, such as when it has a contract that involves pre-payment of particular maintenance. Finally, as shown at point 162, in some cases it may be desirable to have the lessor or owner of the asset have the ability to review and override any refusals to perform maintenance since it has the ultimate responsibility for asset 120. If no approvals are given, the process is terminated at point 164. A review of any automated rules that generated a request for maintenance approval may also be appropriate. When maintenance approval is rejected, any automated rules that generated the original maintenance request can be fine-tuned by including the results of the approval process. Over time, almost all maintenance requests should be generally approved. Information regarding approval is stored in database 78.

For preventative maintenance, it is expected that pre-approval will generally be granted by the necessary parties based on prior agreement as to the nature and timing of such maintenance.

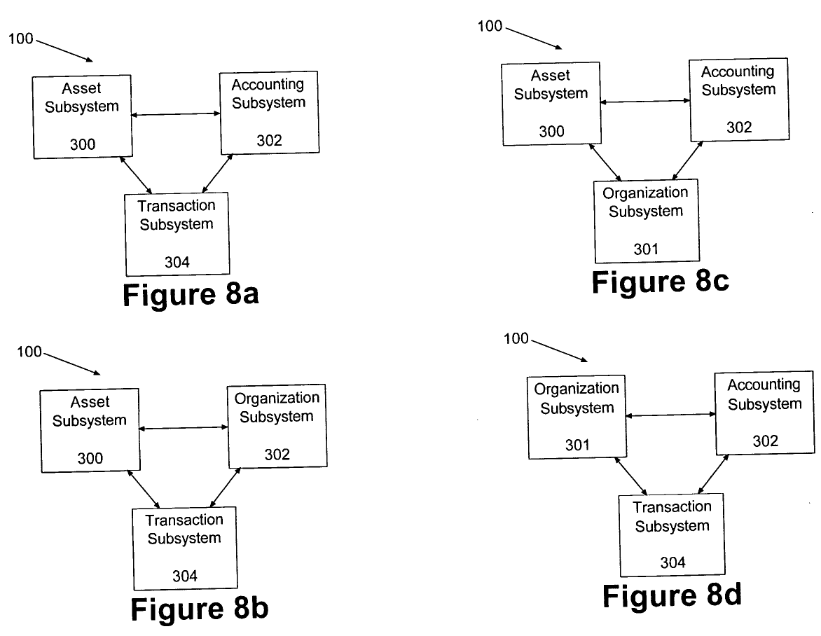

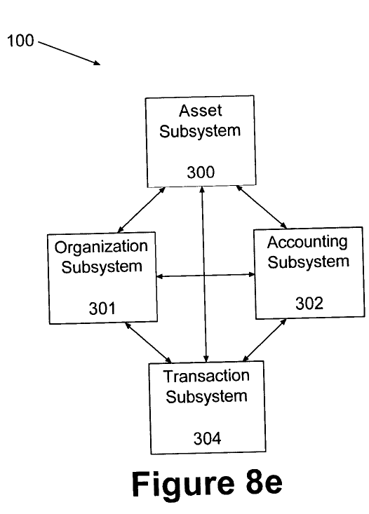

Once maintenance has been approved, a work order 166 is generated. As shown in FIG. 8, work order 166 is sent electronically to appropriate maintenance personnel that contains all of the critical operating data required to effectively schedule and carry out the maintenance. Typically, for example, the data includes an hour meter reading, any fault codes, asset identification criteria, an operator of record, contact information, and asset location. Moreover, based on information contained within the fault code or retrieved from the knowledgebase, information concerning anticipated parts may also be provided as well as the nearest location from where they may be retrieved (e.g., at a customer location, or from a local servicing dealer). Finally, the work order 166 preferably contains the past recent history of the particular asset 120 so that the mechanic can use this information to expedite maintenance.

In a preferred embodiment of the invention, the work order 166 is transmitted electronically to a handheld device 168 associated with specific maintenance personnel assigned to carry out the maintenance. Device 168 includes an appropriate graphical user interface (GUI) that permits the receiving and transmitting of both alphanumeric and graphical based information. Examples of hand held devices include a variety of systems produced that use either the Palm® operating system from Palm, Inc. or a sub-set of Microsoft® Windows® from Microsoft Inc. Moreover, in a more preferred embodiment of the invention, the hand held device 168 is in real-time two-way communication with analysis controller database 78. Thus, under appropriate circumstances the handheld device 168 can access such things as dealer billing systems, inventory listings, customer work order approval records, and fleet management information. Rather than having the work order include the past recent history of the asset 120 to be serviced, it is possible to use the two-way communication link to request the necessary history when advantageous to do so.

Once the maintenance is completed, handheld device 168 is used to update database 78 as shown at point 170, including labor information and an identification of any parts required to effect a repair. If not already clear based on the contents of database 78, the inventory location from which any parts were pulled should also be provided. Ideally, the information is transmitted on a real-time basis from the handheld device 168. Alternatively, however, the information can be transmitted upon routine synchronization of the handheld device with database 78. It is also possible to manually enter the information into the database 78.

The maintenance information is passed to database 78 where it may be used to generate maintenance tracking reports 172, and comprehensive invoices 174 listing both labor and part costs. Since the information is integrated with pre-existing asset information, no re-keying is required. Moreover, as noted above with respect to FIG. 4C, the complete maintenance history of a particular asset or class of assets may be reviewed and analyzed in detail for specific trends of interest.

In addition, when parts are used, as shown at point 176, system 30 preferably permits comparison of the parts used with existing inventory for the specified parts storage location. Based on maintenance trends associated with a class of assets 120 or a specific asset 120, it is possible for the system to automatically order replacement parts for an inventory location if the number of parts in a particular inventory fall below a pre-determined threshold as shown at points 178 and 180. The threshold is calculated at least in part based on an analysis of the prior maintenance of both the asset 120 and the class of assets associated with the asset. Other factors may include the age of the class of assets, the time of the year, usage trends and the like. As one example, in the winter different parts may be required as opposed to in the summer. As another example, more tires may be required for a forklift asset if a number of the assets are reaching a preventative maintenance stage where tires have to be replaced. The system terminates at point 182.

It is also possible to provide online copies of parts catalogs including part numbers and exploded views of parts, including to hand held device 168. In some cases a comparison table of equivalent parts may be provided to reduce part acquisition timing or cost. Moreover, system 30 preferably keeps track of part availability and cost throughout a parts availability network. Thus, no one party is required to keep as many items in stock since ready access to items stored at a different location is possible. Transaction costs in locating and requesting items from different locations is minimized since the information is readily stored and accessible from system 30. Item stock reduction at any one location is also possible for the reasons discussed above where careful quantity controls are implemented.

Under some circumstances it may even make sense to have a central parts depository with inventory actually held and controlled by a third party such as a courier service. For example, the courier service can ship parts as needed to effect a repair or replenish a reduced inventory at a remote location. With a central depository, the cost of maintaining the inventory can be borne by the party having the best ability to do so. For example, if an asset owner 92 has many businesses 90 using a class of assets 120, it may be able to provide economies of scale to the businesses by being responsible for ordering and stocking inventory parts for use by all affected businesses. Non-related businesses may also be provided access to a part inventory at a higher cost, giving them a further incentive to actively participate in system 30 to enjoy improved economies of scale. Thus, system 30 provides enhanced customer service through reduced cost and a more efficient part access and ordering process.

Inventive system 30 provides a number of additional advantages for maintenance. For example, through the use of electronic information transmission and analysis, maintenance information is transferred and available real-time for review and for the initiation of necessary actions such as approval, the tracking of performed maintenance, the ordering of replacement parts to replenish depleted inventories, and automatic invoice generation. Since asset 120 communicates its own maintenance needs in consultation with an appropriate knowledgebase associated with database 78, human intervention is minimized. As more information is gathered over time, the scheduling of preventative maintenance can be optimized to eliminate either too little or too much maintenance. Further, system 30 automates a very paper-intensive and time cumbersome process by permitting direct communication with the various information elements associated with an asset 120. As a result, the flow of data is more effectively controlled, dispersed, routed, monitored, and acted upon. In practice, the number of people involved in the maintenance process can often be reduced while the speed of providing maintenance can be increased. Thus, potential downtime and related performance issues can be more timely addressed.

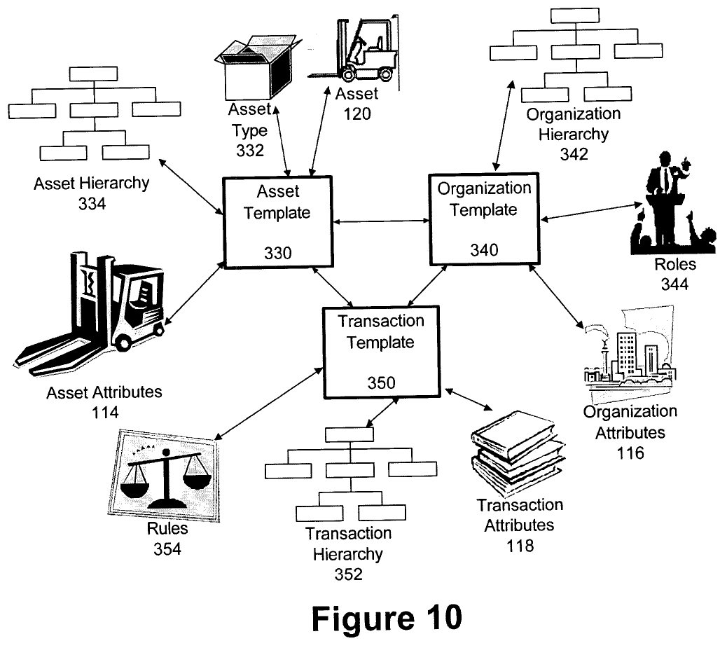

A data acquisition and analysis subsystem 300 is illustrated in FIG. 10. Subsystem 300 facilitates the collection of raw fleet survey data 302 upon initiation of system 30 by a party so that a baseline level of data may be provided to system 30 for consideration and analysis. An account manager 304 collects raw data with respect to each affected asset 120 and all parties having interaction with the asset such as the parties identified with respect to FIG. 5 above. Of course, other parties may also contribute fleet survey data if they have interaction with an asset 120. The data is preferably inputted into a handheld device 168 using pre-defined forms 306, transmitted to a desktop computer 308, and then ultimately stored in analysis controller database 78. To help with analysis of particular data, the process may be reversed, with data pulled from database 78 to desktop computer 308, transmitted to hand held device 168, and used by account manager 304 to perform a desired analysis for any affected party.

Preferably, hand held device 168 uses an operating system 312 provided by Palm, Inc. A forms manager 314 from Puma Technologies, Inc. known as the Satellite Forms software development package is used to generate data forms 306, which are used to enter the required information or display stored data from hand held 168 or from analysis controller database 78. When collecting raw data, account manager 304 follows inquiries associated with form 306 to enter required information. In contrast to manual methods, it is preferably possible to advise when inappropriate data is entered or if a field is missed. Thus, any data entry errors can be addressed on the spot when the source of the original data is readily available. Hand held device 168 stores locally collected data 316 such as fleet survey data 302, may include retrieved data 318 from database 78, and a number of different analysis tools 320 for evaluating the stored data. For example, one analysis tool 320 may use a set of rules to estimate the total life of an asset under the circumstances currently in place at a business 90 and compare them to known “best practices” for the same asset along with proposed process changes to increase asset life to reach the “best practices” level.

Preferably, computer 308 includes an operating system 322 provided by Microsoft such as Windows® 98, Windows® Millenium or Windows® 2000. It has a plug-in 324 provided by the party responsible for hand held operating system 312 to provide a synchronization conduit 326. Synchronization is handled through a conventional or USB serial data port on the desktop computer 308 and a cradle hardware device 328 associated with device 168. During use of synchronization conduit 326, data values and associated data stored on hand held device 168 and desktop computer 308 are interchanged in accordance with parameters provided in forms manager 314 and a corresponding forms manager computer plug-in 330 on desktop computer 308. Desktop computer includes data from hand held device 168, data from database 78 to either be used locally by the computer or transferred to hand held device 168, data received from device 168 or manipulated locally using one or more analysis tools 332, and data to be transmitted to database 78 for long-term manipulation or storage.

For example, when using subsystem 300 to transfer fleet survey data 302 that has been placed into hand held device 168 as locally collected data 316. The data transmitted includes both data elements and lists of value fields identifying a data source and the specific data values populating each data element. The data is then transferred to database 78 from desktop 308 in accordance with pre-determined rules. Preferably, the data is associated with fixed fields that are consistently defined between hand held device 168 and database 78 so that the data merely populates the appropriate fields within database 78 after it is transferred from the hand held device. Alternatively, the data may be uploaded into a local analysis tool 332 of desktop 308 such as a database or spreadsheet program for final manipulation and then storage in asset controller database 78.

More particularly, in a preferred embodiment of the invention an account manager 304 who is about ready to visit a business 90 determines the type of information that is relevant to be collected during the visit. Using the desktop computer, a list of values as well as data query forms are downloaded from asset controller database 78 and stored on the local desktop computer hard drive, and then transferred to hand held device 168.

For example, when first taking an inventory of pre-existing assets for a new business 90, a list of valid value identifiers for forklift analysis may include the following data elements:
1) Overall customer information
2) Customer division information
3) Locations of facilities within each division where forklifts are used
4) Departments within each facility that use the forklifts
5) Broad descriptions of the types of ways or industries for which the forklifts are used
6) For each forklift:
   a) Manufacturer/Supplier
   b) Power supply type
   c) Mast type
   d) Tire type
   e) Forklift attachments
   f) Forklift type/model
   g) Forklift serial number
   h) Any label used by a customer to uniquely identify the forklift
   i) Date the forklift went into service
   j) Number of hours that the forklift has been in use according to its meter.
   k) Lease/rental contract information
   l) Maintenance history
   m) Maintenance contracts.
   n) Forklift dealer
   o) The number of months/and/or usage hours covered pursuant to the manufacturer/supplier warranty.
   p) Original purchase cost
   q) Manufacturing date
   r) Forklift condition (e.g., based on a scale such as new or used)
   s) Application rating (e.g., heavy, medium or light)
   t) Administration fees charged for providing financing/maintenance or the like
   u) Criteria providing feedback concerning the number of hours at which preventative maintenance should be performed
   v) Capacity, typically in pounds or kilograms
   w) Number of hours or shifts the forklift is used each day
   x) Number of days a week that a forklift is used

The tables are downloaded to hand held device 168 using synchronization conduit 326 and the relationship between forms manager 314 and forms manager computer plug-in 330. In practice, the transfer of data value tables and their related values has also included the use of a program written in a product called Sybase Powerbuilder from Sybase, Inc. Under such circumstances analysis controller database 78 is a Sybase database. Further, desktop computer 308 may include a different database manipulation program called DBASE acting as one of the local analysis tools to review and possibly manipulate data received from hand held device 168 or analysis controller database 78 before forwarding it to the receiving device.

The collection of fleet survey data 302 is merely an example of subsystem 300 in use. Moreover, even when an account manager 304 is collecting fleet survey data 302, it is preferred that if some of the data associated with a survey is already stored in database 78 (e.g., customer contact information, divisions, or asset locations), it is used to pre-populate appropriate forms 306 to simplify redundant data entry by the account manager. Further, if an error exists based on an inaccuracy in the pre-existing data, account manager 304 can correct it.

The collected and manipulated data provides a starting point for each asset 120 going forward as well as a base foundation for immediate asset fleet analysis since at least some historical data has preferably been collected for existing assets. Thus, even at the beginning of the utilization of system 300, the initially collected data can be analyzed in accordance with pre-existing data involving other fleets, best practices, and the like, to provide immediate guidance on how to improve current fleet utilization and efficiency. The same subsystem may be used to transfer data and recommendations back to hand held device 168, except that this time forms 306 perform a data presentation function as opposed to a query function. As suggested above, some analysis of data may be performed directly on hand-held device 168 although more sophisticated analysis tools 332 are typically associated with desktop computer 308 or asset controller 51 in view of their enhanced computational power and storage capabilities.

Subsystem 300 has been shown using synchronization. It is recognized of course, that real-time access is also possible between hand held device and either asset controller 51 or desktop computer 308 without the need to use cradle 328. An advantage of real-time access between a hand-held device 168 and database 78 is that information may be immediately transmitted and received, providing access to the full range of data values and associated data available in database 78. The uploading and downloading of pre-created data forms 306 to help facilitate the collection and analysis of data is also expedited. Further, under some circumstances real-time error checking may be available. For example, if an account manager 304 indicates the number of assets available at a physical location and the actual number in database 78 is different, the manager can be asked to undertake verification while still present at the physical location. Otherwise, to the extent that there are discrepancies, they may be considered after data synchronization takes place.

The same methodology discussed with respect to subsystem 300 may also be used by maintenance personnel as discussed with respect to FIG. 8 above. Work order 166 acts as a pre-populated form 306 transmitted to a hand held device 168. Once the maintenance is completed a different form 306 may be used to communicate the necessary maintenance labor and parts information so that a maintenance tracking report 172, invoice 174, and determination of inventory replenishment 178 may be implemented.

The system 30 provides the ability to take data concerning any asset 120 and the interaction of that asset 120 with any party, including user 85, maintenance organization 86, asset manufacturer or supplier 86, business 90, asset owner 92, or other parties/vendors 93. Moreover, groups of assets may be combined. Thus, it is possible to analyze data to identify the cost of owning or using any asset 120 and the productivity of that asset. Moreover, based on an adequately large statistical universe of data it is possible to benchmark asset utilization and cost against others in similar circumstances to identify best practices. Thus, it is possible for efficiency to be maximized while simultaneously minimizing unwanted waste by identifying time and cost saving opportunities. It is also possible to determine those parties providing best practice services with respect to asset utilization (e.g., maintenance) so that their services can be expanded and appropriate recognition given for their efforts. Alternatively, it is possible to identify parties providing unacceptable services so that appropriate remedial action may be taken (e.g., a user 85 has inadequate training to properly use an asset so additional training needs to be provided).

III. Template Processing

The Driver Application Interface and the Template Builder are user defined structures that allow the user 102 to determine the elements and the relationships between those elements. There are no pre-set limits on the elements or templates allowed in the application.

The Template Builder allows the user to determine how they want to view the elements they have added to the application. It gives the user an unlimited number of ways to view their assets, company hierarchy nodes, and financial transactions.

The application configuration is a flexible data model which allows the user to define their attributes, sections, and templates. Using a GUI interface to input their data, the user sets up their display layout whereby they will be able to create an unlimited number of views, reports or templates used to input data then create and retrieve HTML rendition of the template streamed back to the them.

The AIM application enables the collection, storage, viewing and analysis of asset-specific data over the life-cycle of an asset. Companies can use AIM as an analytical tool to increase utilization and productivity, prolong life-spans, reduce costs and decrease risks associated with operating, owning, leasing, or renting assets. AIM is a web-based application that enables portability for any user with internet access and easy deployment of enhancements and upgrades.

A. Subsystem-Level Views

FIGS. 8a-8e illustrate different examples of subsystem-level views of the system 100. An asset subsystem 300 can be used to capture, process, and store all asset related information. An accounting subsystem 302 can be used to define accounting events, and to tie those events to particular asset attributes and transactions. A transaction subsystem 304 can be used to create, modify, and delete different types of transactions, which can themselves be tied to particular types of accounting events. An organization subsystem 301 can be used to create, modify, and delete different groups and/or subgroups (e.g. organizations). Different organizations can define different business/processing rules for the asset subsystem 300, the accounting subsystem 302, the transaction subsystem 304, and any other subsystems.

B. Information Types

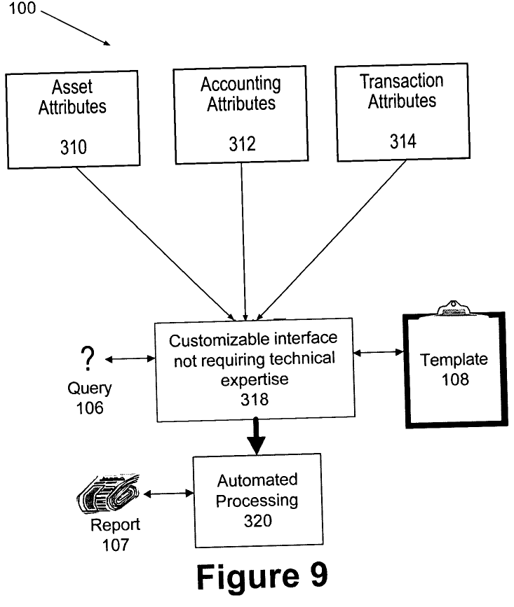

As illustrated in FIG. 9, the system 100 can integrate asset attributes 310, accounting attributes 312, and transaction attributes 314 in the creation of a customizable interface 318 that can be controlled by persons without specialized database knowledge. The customizable interface 318 supports the flexibility of queries 106 as well as the flexibility of the templates 108. The customizable interface 318 can also be used to support various reports 107 and automated processing 320.

C. Template Types

Different types of templates 106 correspond to the different types of information or attributes processed by the system 100. An asset template 330 can be used to define asset types 332, identify specific assets 120, and relationships between asset types in the form of an asset hierarchy 334.

An organization template 340 can define particular organization attributes 116, a variety of roles 344 within the organization, and an organization hierarchy 342 indicating the relationships between organizations (and potentially their processing rules) with respect to the system 100.

A transaction template 350 is used to define particular transaction attributes 118, and transaction rules 354 (such as linkage to particular accounting events). Transaction can be organized into a fully normalized transaction hierarchy 352.

D. Screen Views

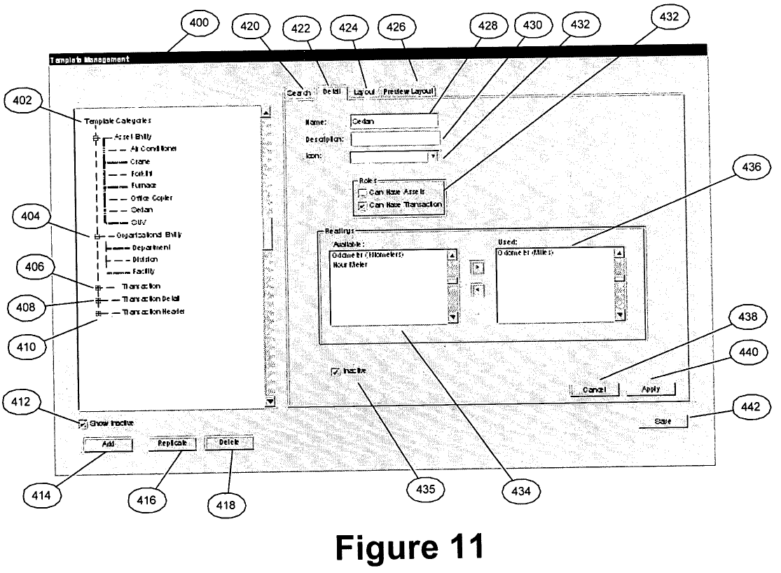

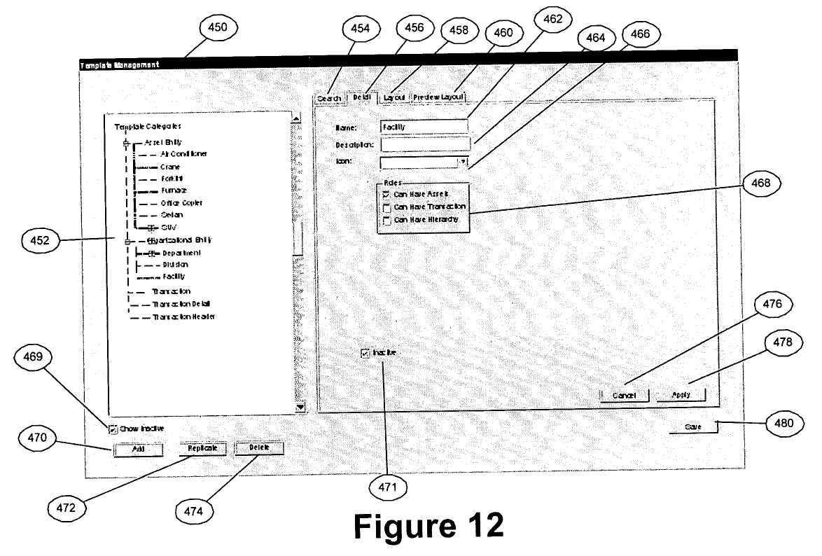

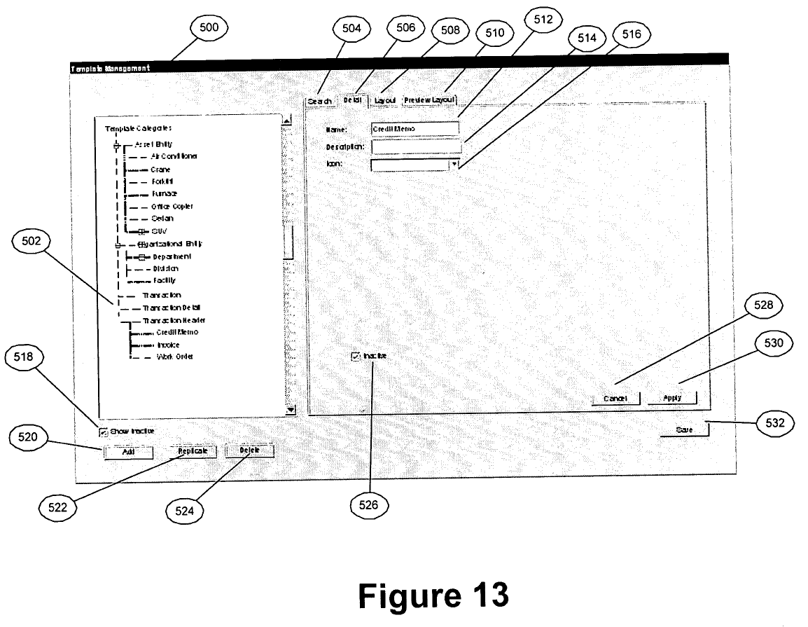

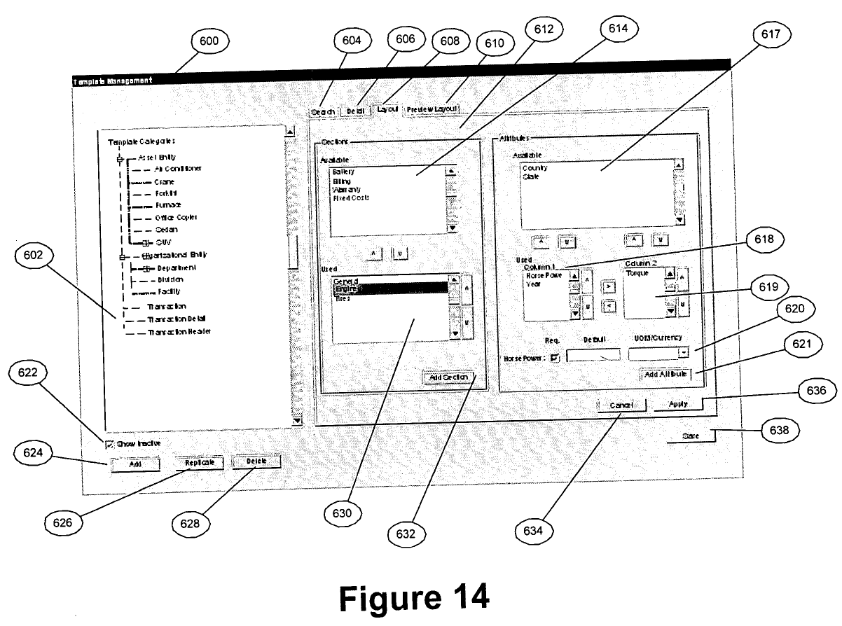

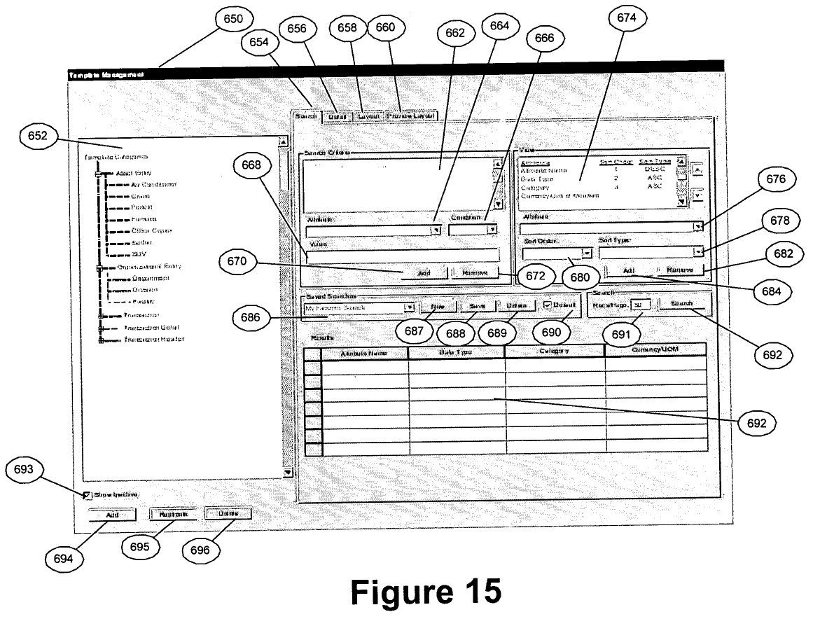

FIGS. 11-15 illustrate different examples of screens that can be used to build, modify, and otherwise manipulate templates 108 used by the system 100.

System Customization

The application enables the system client to customize the software to suit their own specific requirements and those of their customers. Examples of the system's flexibility include:

Flexible company hierarchy entity type definitions including custom attributes and business rules.

Flexible asset type definitions including attributes and business rules.

Flexible financial transaction type definitions with respect to revenues and costs that enable Profit/Loss analysis.

Flexible viewing/reporting capabilities including custom filters for online viewing and exporting of data and custom report creators using On Line Analytical Processing-based (OLAP) functionality.

Flexible look and feel that allows the System Client to “brand” the application

Data Input

The AIM application allows data to be entered into the system via three methods of input:

Manual entry—the most labor intensive and most prone to input errors.

Semi-automated entry—refers to bulk upload capabilities that utilize customized spreadsheet functionality to reduce the time required to input large quantities of data (e.g. assets, financial transactions such as charges from invoices/work orders, usage readings).

Automated entry—the least labor intensive and least prone to input errors. Once initial set-up or mapping is complete, data flows from another system or device (e.g. data logger) into the AIM database.

Custom data import mapping: refers to functionality where users can regularly import financial transaction data into AIM from other systems. To do so requires custom maps to be developed for non-structured reports generated by the user's accounting systems. Next, a cross-reference interface allows users to map specific values from their system to the associated values in AIM.

Wireless data collection: refers to functionality where usage data (e.g. meter readings), alert data (e.g. asset overheating), and/or location data (e.g. GPS coordinates) is automatically imported into the AIM database via an on-demand request or pre-scheduled requests.

Data Storage

The AIM application stores the following types of data:

Company hierarchies

Assets

Financial transactions and associated maintenance/repair/service data with respect to assets and/or company hierarchy entities

Usage data, alert data, location data

The ability to view, add, edit and delete this data is based on a user's functional and data security rights that are established and maintained by the system administrator. Company hierarchy and asset lifetime history are stored to provide an accurate historical perspective of the data. In addition, when data is entered, modified, or deleted, a record of which user performed the action is stored for audit purposes.

Data Viewing and Output

AIM provides multiple formats for viewing and/or exporting data:

Ad Hoc Reports—created via custom view and custom filter functionality. These enable the user to determine which data fields will be displayed on the screen and filter which data results will be included.

Pre-defined printable reports—refer to a set of formatted pre-defined reports that display common asset information. Users can further customize these reports according to criteria such as: reporting levels, data groupings, sorting and begin/end dates.

Data mining reports—refers to the highly flexible On Line Analytical Processing-based (OLAP) functionality. This enables the user to create cross-tab query type of reports where the user can select which fields will represent column headings, row headings, and report values. In addition, this type of report offers the user “drag and drop” capabilities for even greater flexibility.

Exception alerts—custom defined alerts based on user-defined filter criteria and distributed via email.

The user defined template determines how stored information and/or reports are viewed. An outline of how templates are defined is given below:

Flexible company hierarchy

Supports custom hierarchy level definitions

Name (division, work site, client company, etc . . . .)

Customer defined business rules

Can have assets

Can have transactions applied (cost data)

Can include complete company hierarchies for both our customers and their customers

Stores changes in the hierarchy over time

Supports custom (user defined) attributes for any hierarchy level
can be used for descriptive purposes (e.g. size, square feet, etc . . . .)
can be used for export mapping (GL code, IDs from other systems, etc . . . .)

Flexible Asset types

Asset types are defined by each customer

The system can be configured to provide sample Asset type templates that can be customized

Supports custom asset attributes

Static attributes (e.g. serial number, mast height, etc . . . .)

Readings (hour meter, cycles, alerts, etc . . . .)

Lookup lists: user can define a set of available values for a custom attribute (Tire type: non-marking, hard rubber, metal)

Reading attributes can be linked to data logger sensors (NOT in initial release, but in the next one)

Branding

Flexible transactions

Multiple transaction types

Lease

Rent

Depreciation

Interest payment

Asset Management fee

Maintenance contract

PM

Repair

Abuse

Freight

Travel

Misc

Multiple transaction header types (all headers are defined from the perspective of the AIM Client)

External Invoice

Internal Invoice

External Credit memo

Internal Credit memo

Internal Work Order

Customer Work Order

Fixed Revenue

Fixed Cost

Transactions can be dynamically treated as either revenue or cost based on the combination of transaction and transaction header types at report-time

AIM Clients can view P & L data based on costs and revenues from their perspective (e.g. rental transaction may be a revenue)

AIM Clients can set up filters/reports showing cost data from their customer's perspective (e.g. rental transaction may be a cost)

Flexible reporting

Multiple formats

Custom filters (on screen viewing & exporting)

Customizable static reports

like the current PDF reports but with many more user selection options

Each customer will be able to select from a list of available fields to include in the report

OLAP reports

Users may save multiple report templates of each type

Large reports may be queued for delivery via email

Custom defined alerts based on user-defined filter criteria—distributed via email

Asset Entity Template

Organizational Entity Template:

Transaction Header, Transaction, and Transaction Detail Template:

Template Management is an administration area within the AIM application where the user will go to set up the way that they want to view their assets, organizational entities and financial transactions. Prior to entering Template Management, the user will define those attributes that they choose to track. Template Management is the area where they will associate those attributes with a template that they can start to create objects from.

Navigation

The user will navigate to template management through the menu system.

Page Mode

Modify: The Detail tab will be set to Modify if a user selects an existing template to view it.

New: When the user clicks the “Add” button, the detail tab will re-initialize, and clear the fields. The Cancel button will also appear

Page Entry

Template Management

When the page is displayed, the screen is divided into two distinct areas. On the lefts side of the screen, users will see a tree. The tree view will be divided into 5 different template types: Assets, Organizational Entities, Transaction Headers, Transactions, and Transaction Details. Templates will be listed under each of the template types. A tabbed pane (which will serve for providing the user with more information about the selection within the tree view) will appear on the right ⅔rds of the screen. Selecting an item in the tree view will display the details for that item within the tabbed pane.

Upon Entry to the Template Management Area, the “Template” root node is selected in the tree, and the Advanced Search is the first tab, and fronted. Remaining Tabs will appear in the following order: Detail, Layout and Preview. All buttons will be disabled until a template or template category is selected.

Template Detail Tab

Upon entering the Detail Tab for an existing Template, the page will fill the fields as they were last saved for the selected template.

Data Fields

Required Fields

Template Name

The name of the template.

A list of templates is disclosed in Table A.

| Template | | |
|---|---|---|
| Type | Explanation | Examples: |
| Asset | Asset Type | Forklift, Crane, |
| | | Truck, Copier, |
| | | Air Conditioning Unit |
| Organizational | Organizational Role within | Company, Division, |
| Entity | a Company | Region, Facility, |
| | | Department |
| Transaction | Type of Transaction | Work Order, Invoice, |
| Header | | Statement of Work, Credit |
| | | Memo |
| Transaction | Line Item charge for a | Preventive Maintenance, |
| | given entity or asset on the | Oil Change |
| | transaction. | |
| Transaction | Detailed charges (sub- | Tax, Labor, Parts |
| Detail | charge types) for the | |
| | associated transaction. | |

Optional Fields

Description

A Description of the Template. This field may be used to find a template through the Search functionality.

Controls

Tree View

The tree view displays all of the attribute sections, divided into 5 template type areas: Asset, Organizational Entity, Transaction Header, Transaction, and Transaction Detail.

Show Inactive

The show inactive checkbox will allow the user to view and select inactive templates from the tree view control for viewing and editing purposes.

Add

Clicking the Add button will front and re-initialize the Detail tab, ready to accept new data.

Save

Clicking the Save Button will verify that the data entered into the application is correct, and will save the new or changed record to the database.

The Save button is universal to the Attribute Management Screens; meaning that the user has the opportunity to move through the tab area (i.e.: adding attributes to the template layout), and once s/he has done everything that s/he wishes, saving will commit all of the changes that the user has made across all tabs.

The messages defined within this document will only identify those messages that should be raised from this screen. (see Message Box Messages section below)

Cancel

If any changes have been made, then the “Confirm On Exit” message box is displayed (see Message Box Messages section below).

Detail Tab—Delete

Clicking Delete will remove the selected template from the database. In order to successfully perform this action, there may not be any objects created from this template.

Detail Tab—Replicate

Clicking the Replicate button will duplicate all of the properties of the selected item, ready for the user to make modifications to the copy and save as a unique name.

Roles—Can Have Assets checkbox

This can apply to an asset (for component parts) or company hierarchies. Checking this role will determine the business logic when the user clicks the Add (or move) button, within Entity Management, to allow an asset to be added as a child node to the selected, or new, asset (or company hierarchy node).

Roles—Can Have Hierarchy Checkbox

This can apply to company hierarchy nodes only. Checking this role will determine the business logic when the user clicks the Add (or move) button, within Entity Management, to allow a company hierarchy node to be added as a child node to the selected company node.

Roles—Can Have Transactions Checkbox

This can apply to an asset (for component parts) or company hierarchies. Checking this role will determine the business logic when the user clicks the Entity Picker within Transaction Management, to allow an asset, or company node, to be associated as the item incurring the charge on a transaction.

Inactive Checkbox

Checking the Inactive Checkbox will remove the template from the Template Type Pick List in the future when the user is selecting a template type for a new or existing object. Checking the Inactive Checkbox will not change the make-up of any current objects that use that template. It will only prevent users from selecting the template for future objects of that type (i.e.: Asset, Company, Transaction Header, Transaction, and Transaction Detail).

Icon Pick List

The user selects the type of icon they want to use for their template. Icons will only be used for Assets and Company Hierarchy Nodes. The icons are used within the Entity and Transaction Management areas to illustrate to the user viewing the tree view, what type of object the items within the list are.

Readings—Available Readings

This control will only be available on an Asset Type Templates.

The Available Readings List Box will alphabetically display all of the reading type attributes that are available to be added to the selected template. Available readings are defined for the selected template through attribute management.

Once a reading has been used for the template, it will be removed from the Available Readings List Box.

Readings—Move Left/Right Readings Button

These controls will only be available on an Asset Type Templates.

The Readings Move Left/Right buttons are positioned in between the Available Readings List Box and the Used Readings List Box. They are used to add or remove readings to/from the template.

When an item is selected in the Available Readings List Box, the Move Right Button is disabled. The user may click the Move Left Button to add the selected reading to the template. The Move Right Button will add the reading alphabetically to the Used Reading List.

When an item is selected in the Used Readings List Box, the Move Right Button is disabled. The user may click the Move Left Button to remove the selected reading from the template.

Readings—Used Readings

This control will only be available on an Asset Type Templates.

The Used Readings List Box indicates which meter types will be used for the selected asset.

Business Logic

Roles are specific to the template type that the user is creating

Readings are only available on Asset Type templates

Security Requirements:

If Users have the Security Rights to view Template Management, they will have full access to Template Management: to Add, Edit and Delete templates.

Audit Trail:

There is no Audit Trail for Templates

A list of Messages is disclosed in Table B:

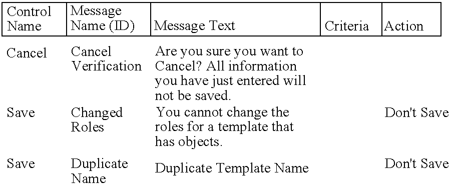

Page Name: Template Management—Layout

Template Management is an administration area within the AIM application where the user will go to set up the way that they want to view their assets, company hierarchy nodes and financial transactions. Prior to entering Template Management, the user will define those attributes that they choose to track. Template Management is the area where they will associate those attributes with a template that they can start to create objects from.

The Layout tab's functionality is to allow the user to add, edit and arrange sections and attributes on the template, as well as defining an attribute as required and setting its default value for the template.

Navigation

The user will navigate to template management through the menu system, and then click the Layout Tab once in Template Management.

Page Mode

Modify: The Detail tab will be set to Modify if a user selects an existing template to view it.

Page Entry

Template Management

When the page is displayed, the screen is divided into two distinct areas. On the lefts side of the screen, users will see a tree. The tree view will be divided into 5 different template types: Assets, Organizational Entities, Transaction Headers, Transactions, and Transaction Details. Templates will be listed under each of the template types. A tabbed pane (which will serve for providing the user with more information about the selection within the tree view) will appear on the right ⅔rds of the screen. Selecting an item in the tree view will display the details for that item within the tabbed pane.

Upon Entry to the Template Management Area, the “Template” root node is selected in the tree, and the Advanced Search is the first tab, and fronted. Remaining Tabs will appear in the following order: Detail, Layout and Preview. All buttons will be disabled until a template or template category is selected.

Template Layout Tab

Upon entering the Layout Tab for a template, the page will fill the fields as they were last saved for the selected template. If the template is new, the Used Sections and Used Attributes List Boxes will be empty.

Data Fields

Required Fields

none

Optional Fields

Layout Tab—Attribute Default Value Text Box

When an attribute is selected within the Used Attributes Column 1 or Column 2, the user will have the opportunity to set a default value for the attribute on the current template. When creating an object from the template, the default value will be pre-filled for the specified field. The user will have the choice upon object creation of leaving the default value as the saved value, or changing it to another appropriate value.

A list of data types is disclosed in Table C.

| Data Types | Valid Default Values |
|---|---|
| Yes/No (Check boxes) | 1 or 0 |
| Date | Any Valid Date format |
| Number | Any whole number |
| Decimal | Any number |
| Currency | Any number |
| Long Text (comments) | Any string |
| Lookup (pick lists) | Any String (preferably one that |
| | exists within the attribute's pick list) |
| Reading | Any Number |

Controls

Tree View

The tree view displays all of the attribute sections, divided into 5 template type areas: Asset, Organizational Entity, Transaction Header, Transaction, and Transaction Detail.

Show Inactive

The show inactive checkbox will allow the user to view and select inactive templates from the tree view control for viewing and editing purposes.

Add

Clicking the add button will front and re-initialize the Detail tab, ready to accept new data for template creation.

Save

Clicking the Save Button will verify that the data entered into the application is correct, and will save the new or changed record(s) to the database.

The Save button is universal to the Template Management Screens; meaning that the user has the opportunity to move through the tab area (i.e.: adding attributes to template layout, changing template icons and roles), and once s/he has done everything that s/he wishes, saving will commit all of the changes that the user has made across all tabs.

The messages defined within this document will only identify those messages that should be raised from the Layout Tab. (see Message Box Messages section below)

Cancel/Exit

If the attribute detail window is being viewed within a pop up window, the Cancel button will returns the user to the initiating window. If any changes have been made, then the “Confirm On Exit” message box is displayed.

Layout Tab—Available Sections

The Available Sections List Box will alphabetically display all of the sections that are available to be added to the selected template. Available sections are defined for the selected template through section management. Available sections will be those sections that appear as specific to the template type (i.e.: Asset, Company Hierarchy, Transaction Header, Transaction, or Transaction Detail) that is being created.

Once a section has been used for the template, it will be removed from the Available Sections List Box.

Layout Tab—Sections Move Up/Down Buttons

The Sections Move Up/Down buttons are positioned in between the Available Sections List Box and the Used Sections List Box. They are used to add or remove sections to/from the template.

When an item is selected in the Available Sections List Box, the Move Up Button is disabled. The user may click the Move Down Button to add the selected section to the template. The Move Down Button will add the section to the bottom of the Used Section List.

When an item is selected in the Used Sections List Box, the Move Down Button is disabled. The user may click the Move Up Button to remove the selected section from the template. If there are attributes associated with the section, the removal of a section will also place all of its assigned attributes back in the Available Attributes List Box. (See Assumptions)

Layout Tab—Used Sections

The Used Sections List Box indicates which sections have been placed on the template for the purpose of grouping attributes. The sections appear in the list box as they appear on the template.

Layout Tab—Used Sections Ordering Buttons

The Used Sections Ordering buttons allow the user to determine the order of sections within the template. When an item is selected within the Used Sections List Box, clicking the order up button will move the selected item up once for each time the button has been clicked. Once the selected item is at the top of the list box, the order up button is disabled, indicating that the item cannot be moved any further up within the list.

Clicking the order down button will move the selected item down once for each time the button has been clicked. Once the selected item is at the last in the list box, the order down button is disabled, indicating that the item cannot be moved any further down the list.

The Used Sections Ordering Buttons are disabled when there is no selection within the Used Sections List Box.

Layout Tab—Available Attributes

The Available Attributes List Box will alphabetically display all of the attributes (with the system required attributes colored red, and at the top) that are available to be added to the selected template. Available attributes are defined for the selected template through attribute management. Available attributes will be those attributes that appear as specific to the template type (i.e.: Asset, Org Entity Hierarchy, Transaction Header, Transaction, or Transaction Detail) that is being created.

Once an attribute has been used for the template, it will be removed from the Available Attributes List Box.

Layout Tab—Used Attributes; Column 1 & Column 2

The Used Attributes List Box indicates which attributes have been placed on the template. Since Templates will have 2 symmetrical columns of attributes, the Column 1 & Column 2 List Boxes represent the columns as they appear on the template. The attributes appear in the list box in the order and position that they appear on the template. (See Business Rules)

Layout Tab—Used Attributes; Column 1 & Column 2 Ordering Buttons

The Used Attributes Ordering buttons allow the user to determine the order of attributes within the columns for each section within the template. When an item is selected within the Used Attributes List Box, clicking the order up button will move the selected item up once for each time the button has been clicked. Once the selected item is at the top of the list box, the order up button is disabled, indicating that the item cannot be moved any further up within the list.

Clicking the order down button will move the selected item down once for each time the button has been clicked. Once the selected item is at the last in the list box, the order down button is disabled, indicating that the item cannot be moved any further down the list.

The Used Attributes Ordering Buttons are disabled when there is no selection within the Used Attributes (Columns 1 or 2) List Box. The only way to move an attribute between sections is to remove it from the section in which it resides, and then add it to the desired section.

Layout Tab—Attributes Move Up/Down Buttons

The Attributes Move Up/Down buttons are positioned in between the Available Attributes List Box and the Used Attributes List Box. They are used to add or remove attributes to/from the template. At least one section must be added to the template in order to add an attribute to the template.

When an item is selected in the Available Attributes List Box, the Move Up Button is disabled. The user may click the Move Down Button to add the selected attribute to the template. The Move Down Button will add the attribute to the bottom of the Used Attribute List.

A section must be selected within the Used Sections List Box. If an item is not selected in the Used Sections List Box, the Move Down Button is disabled.

When an item is selected in the Used Attributes List Box, the Move Down Button is disabled. The user may click the Move Up Button to remove the selected attribute from the template. (See Assumptions)

Layout Tab—Attributes Move Left/Right Buttons

The attributes Move Left/Right Buttons allow the user to balance the number of attributes between the two columns. Selecting an attribute in Column 1 will disable the Move Left Button. Clicking the Move Right Button will position the selected attribute in Column 2 at the bottom of the list. Selecting an attribute in Column 2 will disable the Move Right Button. Clicking the Move Left Button will position the selected attribute in Column 1 at the bottom of the list.

Layout Tab—Required Attribute checkbox

When an attribute is selected within the Used Attributes Column 1 or Column 2, the user will have the opportunity to set the attribute as required on the current template.

Required is disabled for checkbox type attributes.

Layout Tab—Currency/Unit of Measure

When a number or currency data type attribute is selected within the Used Attributes Column 1 or Column 2, the user will have the opportunity to set the default currency type (USD, CDN, ¥, £, [symbol] ) or unit of measure for number type fields (lbs, kg, cc, ft, km, g, oz) for objects created from the template.

Layout Tab—Add Attribute Button

Allows the user to add an attribute on the fly. Clicking the Add Attribute Button will post the Attribute Management area of the AIM application in its own window.

Layout Tab—Add Section Button

Allows the user to add a section on the fly. Clicking the Add Section Button will post the Section Management area of the AIM application in its own window.

Layout Tab—Delete

Allows the user to delete a template. Deleting a template will remove the template from the database.

Business Logic

All attributes must be associated with a section.

Removal of a section will place attributes associated with that section back in the pool of available attributes.

If a default value has been set for the attribute on another template, it does not have to be the same value.

The number of attributes within one of the columns must be equal to or no more than 1 less (or greater) than that of the other column. Meaning: If the number of attributes within a section is even, the number of attributes must be as equally split between the two columns. If the number of attributes within a section is odd, the number of attributes cannot be as equally split between the two columns, and so the difference between the number of attributes in column 1 and column 2 must be no greater than 1. If the difference in the number of attributes between column 1 and 2 is greater than 1, upon save, the last attribute(s) is the greater than column will transfer to the less than column behind the list of attributes which already resides there. No warnings or error messages will be raised.

If a section has no associated attributes, upon save, the section will be removed from the template.

If no default value is set for a lookup, the first item within the display list should display.

If the user has typed in a default value for a lookup, and the lookup is a child, reverse lookup the appropriate value for the parent.

If the user has typed in a default value for a lookup, but the default value is not an exact match of the list items, display the default value.

If the user has typed in a default value for a lookup, but the default value is not an exact match of the list items, display the default value—if the lookup is a child, display the default value (as defined above) in the parent lookup.

Prior to deleting a template, a user must remove all objects from the associated template.

If a section is using only 1 column for its attributes, the attribute fields will span the page.

System Required attributes for each template type are disclosed in Table D:

| Template Type | Attributes |
|---|---|
| Asset | Unit ID |
| | Serial Number |
| | Model |
| | In Service Date |
| Hierarchy | Name |
| Transaction Header | Reference # |
| | Currency |
| | Amount |
| | Date |
| | Locked |
| | Comment |
| Transaction | Date |
| | Amount |
| | Entity |
| | Comment |
| | Transaction Description |
| Detail | Amount |
| | Line Description |

System generated attributes on each template type are disclosed in Table E:

| Template Type | Attributes |
|---|---|
| Asset | Asset Template |
| | Make |
| | Model |
| Hierarchy | Entity Template |
| Transaction Header | Transaction Header Template |
| | Transaction Grid |
| Transaction | Transaction Template |
| | Detail Grid |
| | Entity |
| | Entity Readings |
| Detail | Detail Template |

Security Requirements:

Access to Template Management will be present, or not. There will be no “Viewing Only” security access.

Users may or may not have access to Section Management or Attribute Management.

Users must have appropriate access in order to delete a template.

Audit Trail:

There is no audit trail for Template Management.

Messages are disclosed in Table F:

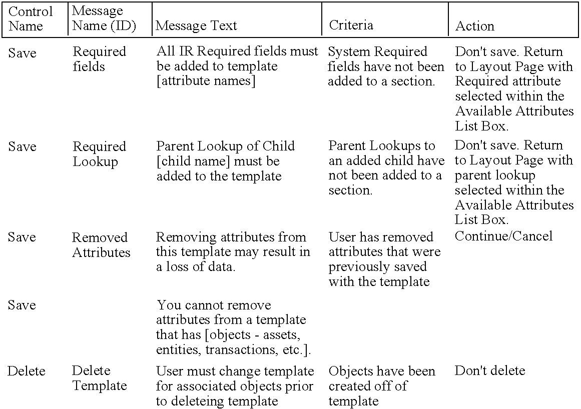

Template Management—Search

Template Management is an administration area within the AIM application where the user will go to set up the way that they want to view their assets, company hierarchy nodes and financial transactions. Prior to entering Template Management, the user will define those attributes that they choose to track. Template Management is the area where they will associate those attributes with a template that they can start to create objects from.

The main function of the Attributes Search is to locate attributes based on selection criteria, such as: list all of the attributes of date type data type who are company type attributes. The Search Tab allows users to locate attributes within their system by specifying known values about the attribute. This document will describe the functionality of the Search Tab.

The Search Tab allows users to locate organizational entities and assets within their organizational structure by specifying known values for specific attributes of the object.

Navigation

The user will navigate to template management through the menu system.

Page Mode

Modify: If the user has access to Template Management, the user will only have modify access.

Page Entry

Template Management

When the page is displayed, the screen is divided into two distinct areas. On the lefts side of the screen, users will see a tree. The tree view will be divided into 5 different template types: Assets, Organizational Entities, Transaction Headers, Transactions, and Transaction Details. Templates will be listed under each of the template types. A tabbed pane (which will serve for providing the user with more information about the selection within the tree view) will appear on the right ⅔rds of the screen. Selecting an item in the tree view will display the details for that item within the tabbed pane.

Upon Entry to the Template Management Area, the “Template” root node is selected in the tree, and the Search is the first tab, and fronted. Remaining Tabs will appear in the following order: Detail, Layout and Preview. All buttons will be disabled until a template or template category is selected.

Search Tab

Upon entering the Search Tab, the page will display with the current default search criteria and set up filled in the fields. The user will have an opportunity to make any modifications to the search settings, or select a different search. If the user does not have a search set as a default, then the Criteria and View areas will be blank.

Data Fields

Required Fields

Recs/Page

The Recs/Page text box allows the user to determine the number of records they see at a time. The Recs/Page field will be pre-filled with the user-defined default (defined within their preferences).

Optional Fields

none

Controls

Tree View

The tree view displays all of the attribute sections, divided into 5 template type areas: Asset, Organizational Entity, Transaction Header, Transaction, and Transaction Detail. Within each of the template categories, the templates available for each of those categories will be listed in ascending alphabetical order.

When the user double clicks an item within their results grid on the search tab, the tree view will expand to display the selected item.

Show Inactive

The show inactive checkbox will allow the user to view and select inactive templates from the tree view control for viewing and editing purposes.

Add

Clicking the Add button will front and re-initialize the Detail tab, ready to accept new data.

Save

Clicking the Save Button will verify that the data entered into the application is correct, and will save the new or changed record to the database.

The Save button is universal to the Template Management Screens; meaning that the user has the opportunity to move through the tab area (i.e.: adding attributes to the template layout), and once s/he has done everything that s/he wishes, saving will commit all of the changes that the user has made across all tabs.

Cancel

If any changes have been made, then the “Confirm On Exit” message box is displayed (see Message Box Messages section below).

Criteria List Display—Criteria

The Criteria List Display will display the list of criteria that the user has chosen to locate the template. All entries will be ‘anded’ together (as opposed to an “or” statement). When clicking one word of a statement, the entire statement should be selected.

Attribute Pick List—Criteria

The Attribute Pick List serves as a way of setting comparison values. The Attribute pick list will fill with generic descriptors of data found within the database. The following attributes should also appear within the pick list for Management Area will include the following attributes:

Attribute (for purposes of finding a template with a specific attribute)

Required Attribute (for purposes of finding a template where a specific attribute is required)

Attribute Default

Section (for purposes of finding a template with a specific section)

Template Type (Asset, Org Entity, Trans Header, etc.)

Role—Can have Hierarchy

Role—Can have Transactions

Role—Can have Assets

Template Name

Inactive

Condition Pick List

The Condition Pick List will contain the conditions that are relevant to the data type of the selected attribute in the Attribute Pick List disclosed in Table G

| String | Date | Number | Check Boxes |
|---|---|---|---|
| Equals | Today | Equals | Enabled (is |
| | | | checked) |
| Greater Than | Last Month | Greater Than | Disabled (is not |
| | | | checked) |
| Less Than | This Month | Less Than | |
| Greater Than or | Equals | Greater Than or | |
| Equals | | Equals | |
| Less Than or | Greater Than | Less Than or | |
| Equals | | Equals | |
| Not Equal To | Less Than | Not Equal To | |
| Starts With | Greater Than or | | |
| | Equals | | |
| Ends With | Less Than or | | |
| | Equals | | |
| | Not Equal To | | |

Value Text Box—Criteria

The Value Text Box will hold the value that the data in the database will be evaluated against in conjunction with the Condition Pick List value.

### EXAMPLE

If I want to find all of the Transaction templates that have the “State” Attribute on it, I will create the following statements in Table H:

| | Statement 1 | Statement 2 |
|---|---|---|
| Attribute | Template Type | Attribute |
| Condition | Equals | Contains |
| Value | Transaction | State |

Creating these two statements and adding them to the Criteria List Display will find all of the Transaction templates in the database that contain the State attribute within their layout.

Apply Button—Criteria

The Apply button will select the values from the Attribute Pick List, Condition Pick List, and the Value Text Box, will place the data in the Criteria List Display, and re-initialize the fields—ready for a new set of criteria.

Remove Button—Criteria

The Remove button allows the user to remove the selected criteria set from the Criteria List Display. The Remove button will be disabled until a criteria set is selected.

View List Display—View

The View List Display will display the list of columns top down as the user has chosen to display them left to right. In addition to the list of results display columns, the View List Display will also indicate if the columns have a sort applied to them, and what order in which the columns are sorted.

Attribute Pick List—View

The Attribute Pick List for the View area of the Search tab allows the user to specify which fields s/he would like to see.

Sort Order Pick List—View

The Sort Order pick list works in conjunction with the Attribute pick list. Within the result set, the user has the opportunity to select how s/he would like the results sorted. This pick list is required when a Sort Type has been defined for the column.

The Sort Order pick list holds numeric values. The values will always be 1 more than there are columns defined within the View List Display.

Selecting a number that is already in use by another column already defined, the current item will receive that numbered sort, and all columns already added to the View List Display with the same number and greater will shift 1 number larger.

### EXAMPLE

I have the following view defined for my Template results as disclosed in Table I:

| Attribute | Sort Order | Sort Type |
|---|---|---|
| Template Name | 1 | Descending |
| Attribute Name | 2 | Ascending |
| Section Name | 3 | Ascending |
| Category | | |

If I add inactive to the List with a Sort Type of Ascending, and a Sort Order of 2, the View Display List will adjust as following as disclosed in Table J:

| Attribute | Sort Order | Sort Type |
|---|---|---|
| Template Name | 1 | Descending |
| Attribute Name | 3 | Ascending |
| Section Name | 4 | Ascending |
| Category | | |
| Inactive | 2 | Ascending |

Sort Type Pick List—View

The Sort Type pick list will contain two (2) items: Ascending, and Descending. The Sort Type pick list allows the user to specify how the results of their search will be displayed. This pick list is required when specifying a sort order.

View Order Up/Down Buttons—View

The View Move Up/Down buttons are positioned to the right of the View List Display Box. They are used to adjust the order of the column display left to right as they appear in the View List Display Box top down.

When an item is selected within the View List Display Box, clicking the order up button will move the selected item up once for each time the button has been clicked. Once the selected item is at the top of the list box, the order up button is disabled, indicating that the item cannot be moved any further up within the list.

Clicking the order down button will move the selected item down once for each time the button has been clicked. Once the selected item is at the last in the list box, the order down button is disabled, indicating that the item cannot be moved any further down the list.

Apply Button—View

The Apply button will select the values from the Attribute, Sort Order, and Sort Type Pick Lists, and will place the data in the View Display List, and re-initialize the Attribute, Sort Order, and Sort Type fields—ready for a new set of criteria.

Remove Button—View

The Remove button allows the user to remove the selected criteria set from the View List Display. The Remove button will be disabled until a criteria set is selected.

Search Pick List—Saved Searches

The Search pick list displays all of the saved searches for the selected management area, specific to the type of item selected (if applicable). Selecting a search from the Searches pick list will display the definition of that search in the Criteria List Display and the View List Display.

New Button—Saved Searches

Clicking the New button will clear the Criteria List Display, the View List Display, Results Grid and the Search Pick List. It allows the user to begin a new search.

Save Button—Saved Searches

Clicking the Save button will save changes to an existing search, or add a new search to the database.

Delete Button—Saved Searches

Clicking the Delete button will delete the selected search in the Searches pick list, as well as all of its criteria and viewing specifications.

Default Checkbox—Saved Searches

Checking the Default check box will set the active item in the Search pick list as the default search. The default search is the search that will populate all fields when the tab is displayed.

Search Button

Clicking the Search Button will allow the user to start the search of the database with the search criteria that they have populated within the Criteria List Display.

Results Grid

The Results Grid will populate with the records that have matched the selection criteria within the Criteria List Display. Double clicking on a record will locate it in the Template tree view control, and highlight the chosen item.

Business Logic

A Search does not have to be saved in order to run the Search.

One default search per root item per management area may be set.

If there is already a default search defined, the newly set default will be set as the default, and the previously default search will no longer be default.

Security Requirements:

There are no security rights for the Search tab. If users have access to Entity Management, they will have access to Search entities.

Audit Trail:

There is no Audit Trail for the Search tab.

Messages disclosed in Table K:

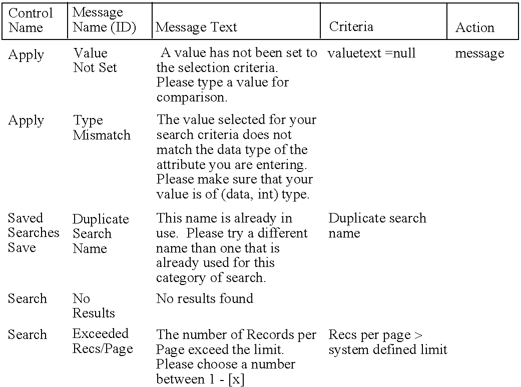

E. Process Flow Views

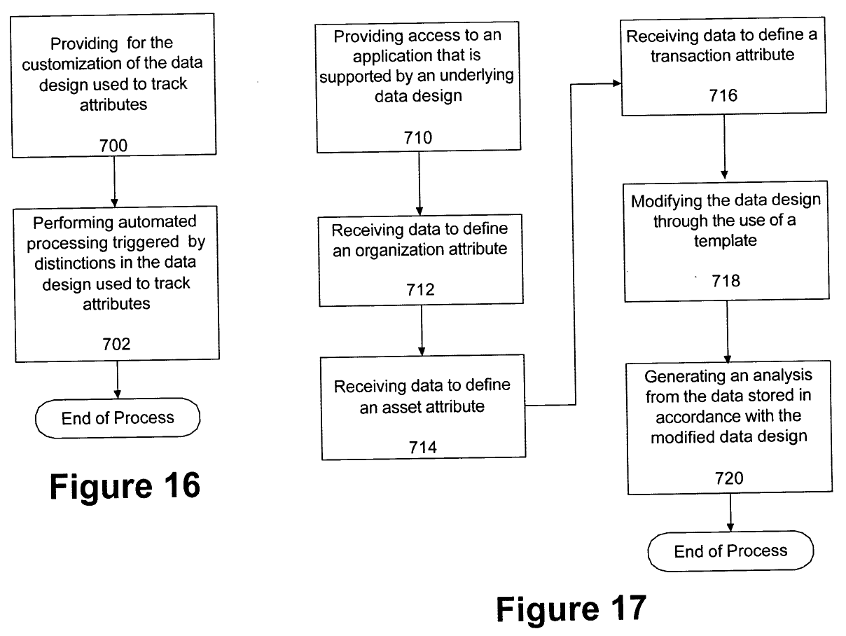

FIGS. 16 and 17 illustrates various process flow views of the system 100.

1. Automated Processing Relying on Customized Data Design

At 700, the customization of the data design is made accessible to a person with business domain expertise, but without information technology or database expertise. At 702, automated processes are triggered by distinctions in the data design used to track various attributes. The process then ends.

2. Data Design Modification

At 710, access is provided to an application that can interact with a data design 113. At 712, data is received to define an organization attribute. At 714, data is received to define an asset attribute. At 716, data is received to define a transaction attribute. At 718, the data design 113 is modified through the use of a template 108. At 720, an analysis is generated from the data stored in accordance with the modified/customized data design 113. The process then ends.

IV. Query Builder

The flip side of modifying the data design 113 through various templates 108, is the ability to generate highly granular customized reports 107 from corresponding granular customized queries 106. The system 100 is flexible, allowing users 102 to define the fields they use. The system 100 can give them the ability to create dynamic reports from their defined fields, not from fields that someone else has pre-selected and implemented as a part of the application. The Query Builder gives users 102 an unlimited number of search and retrieve permutations.

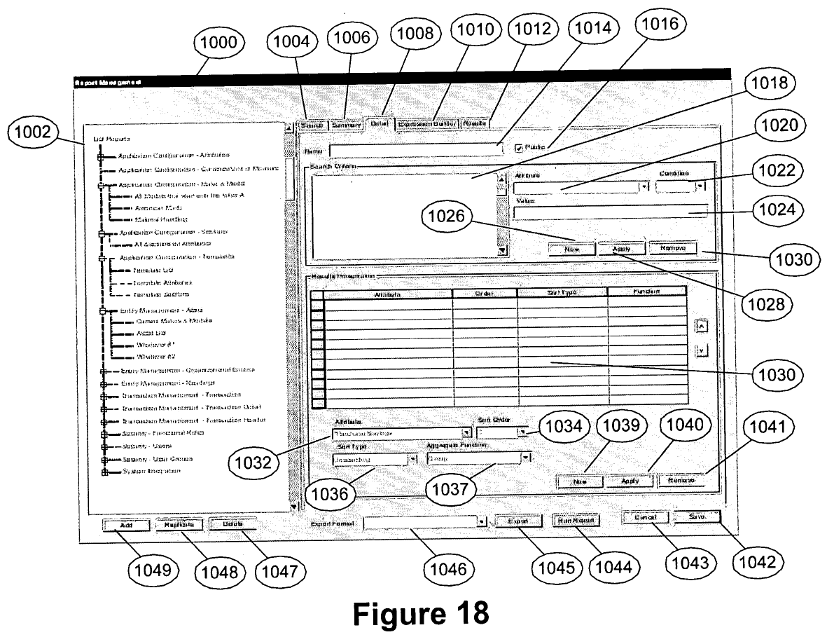

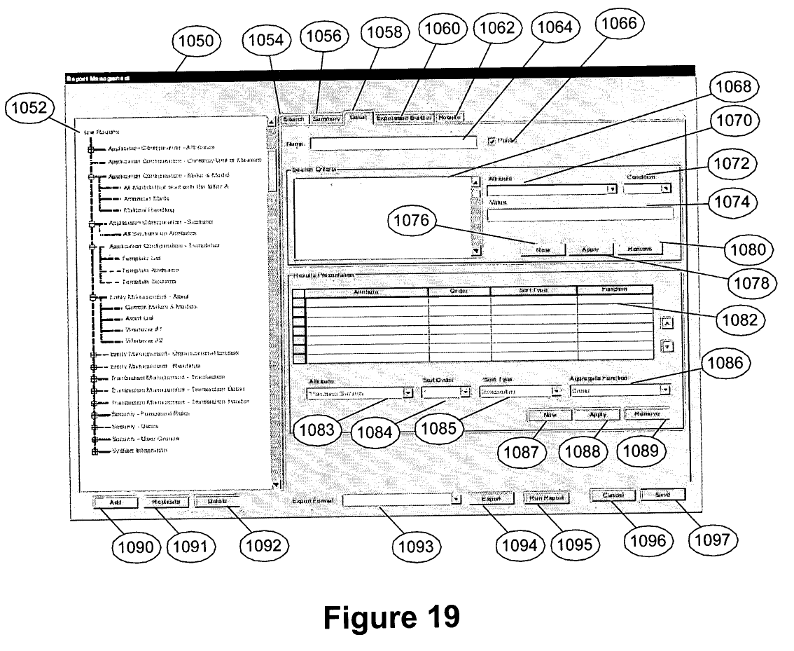

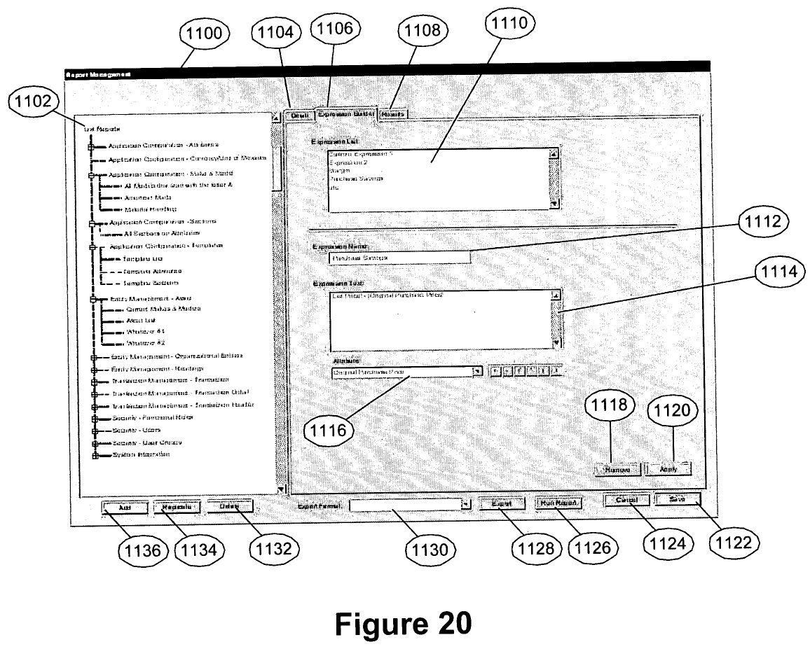

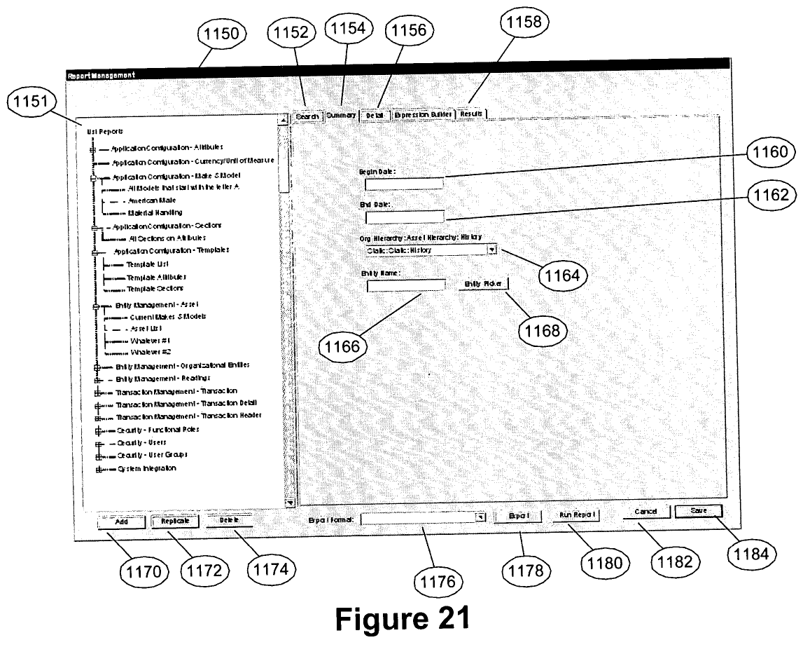

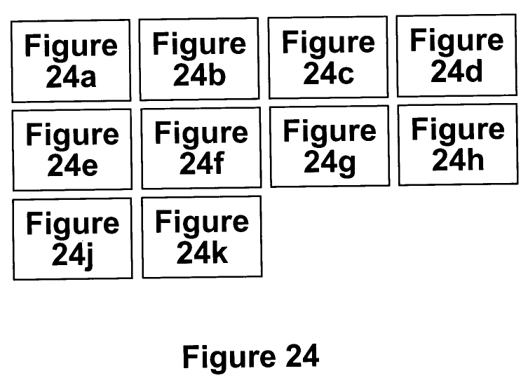

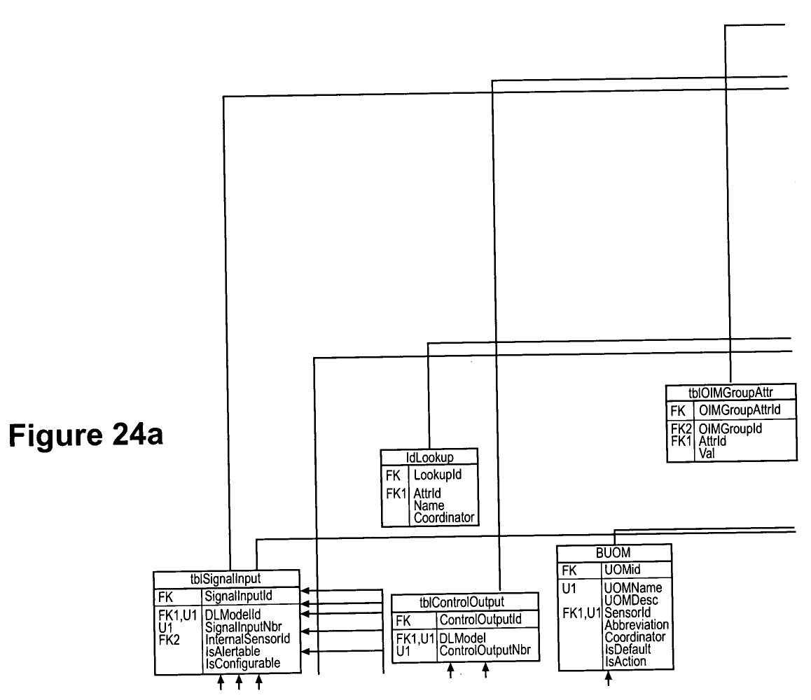

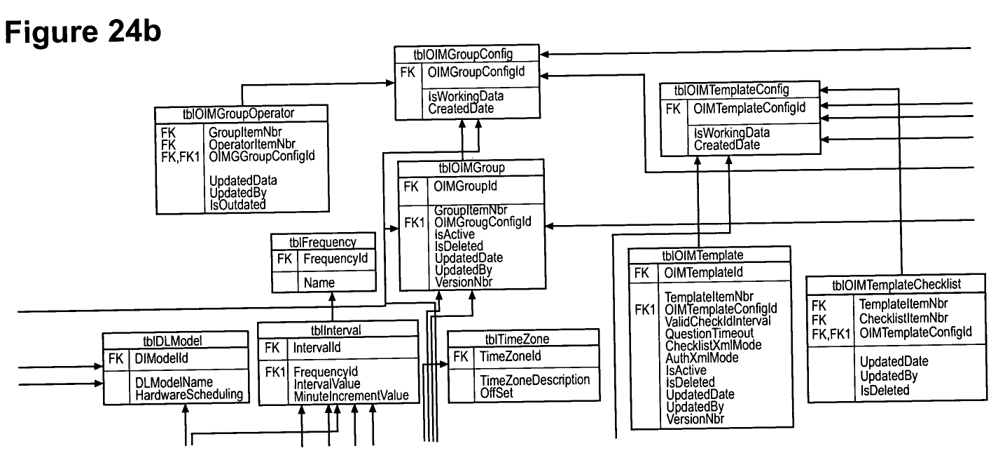

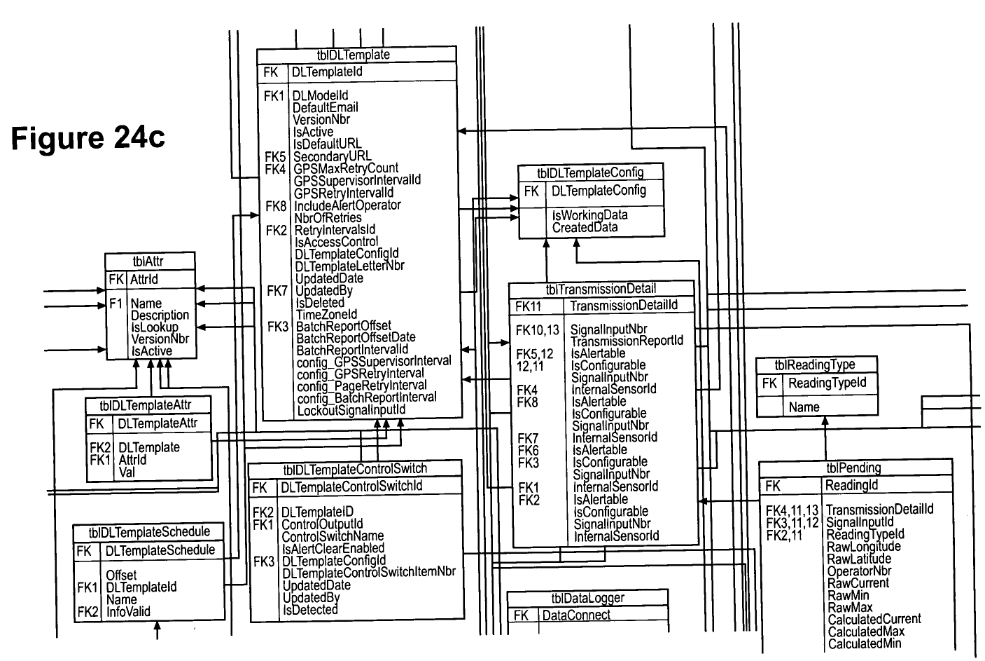

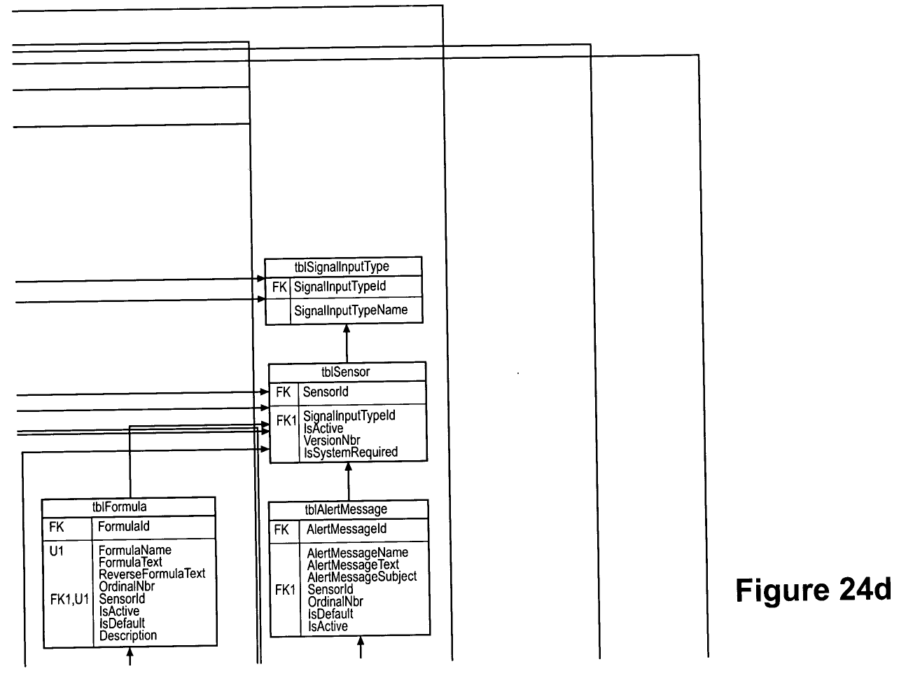

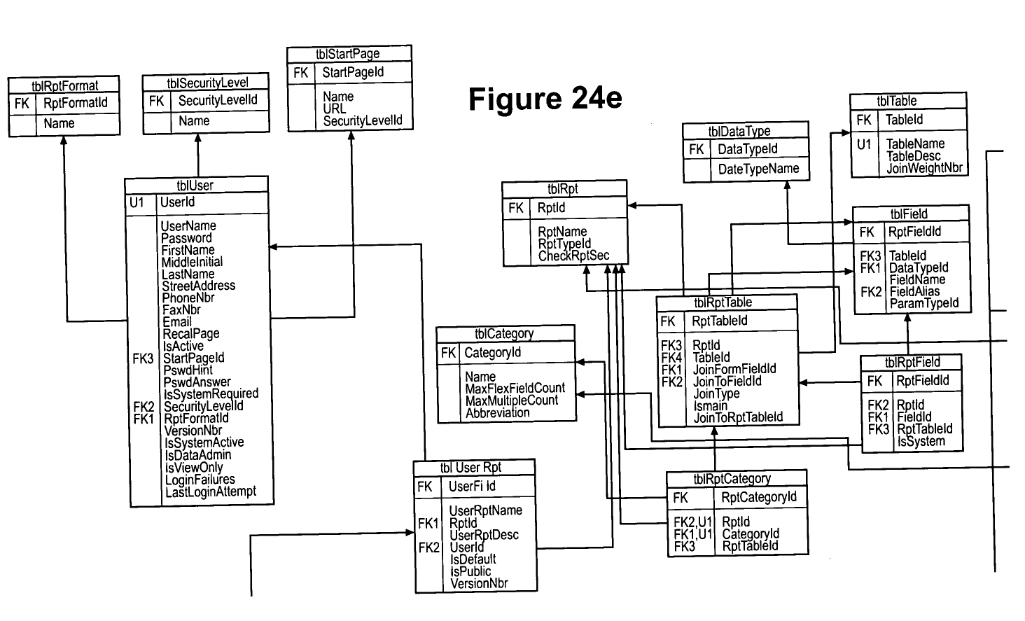

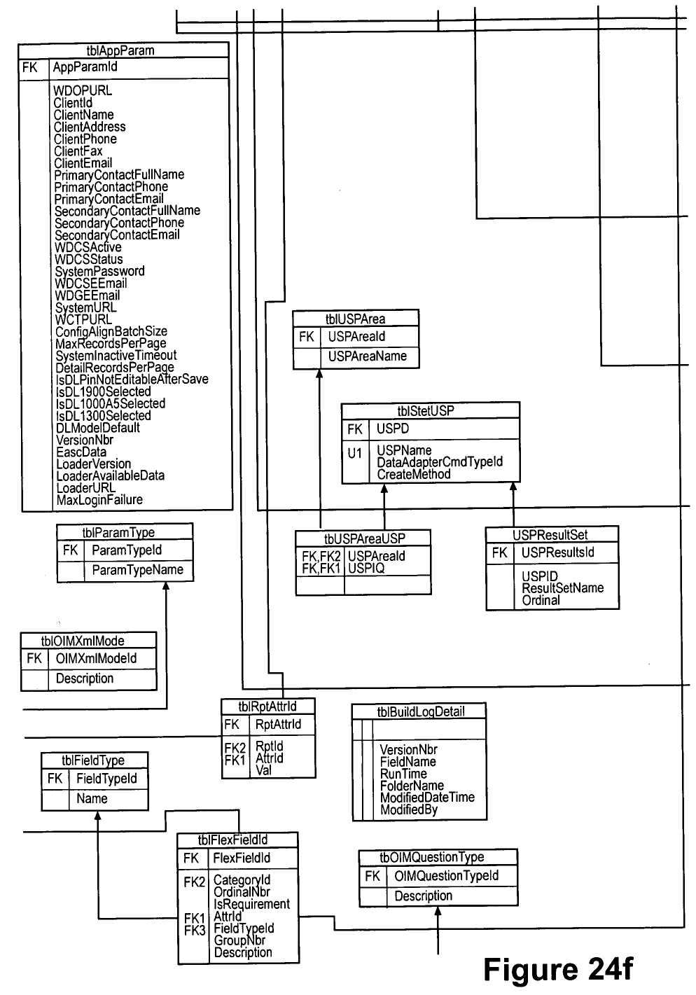

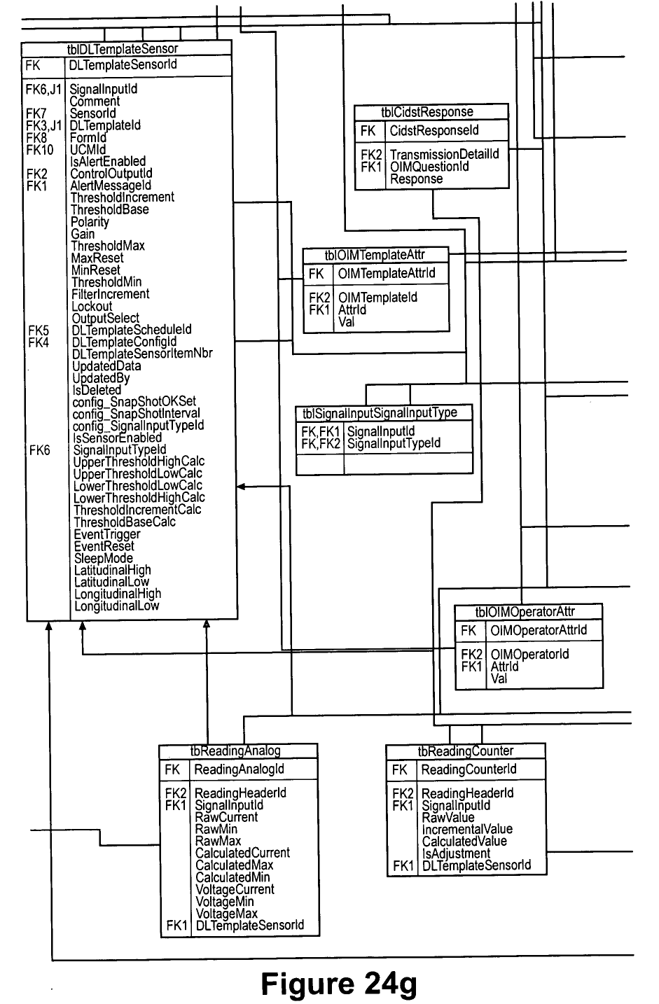

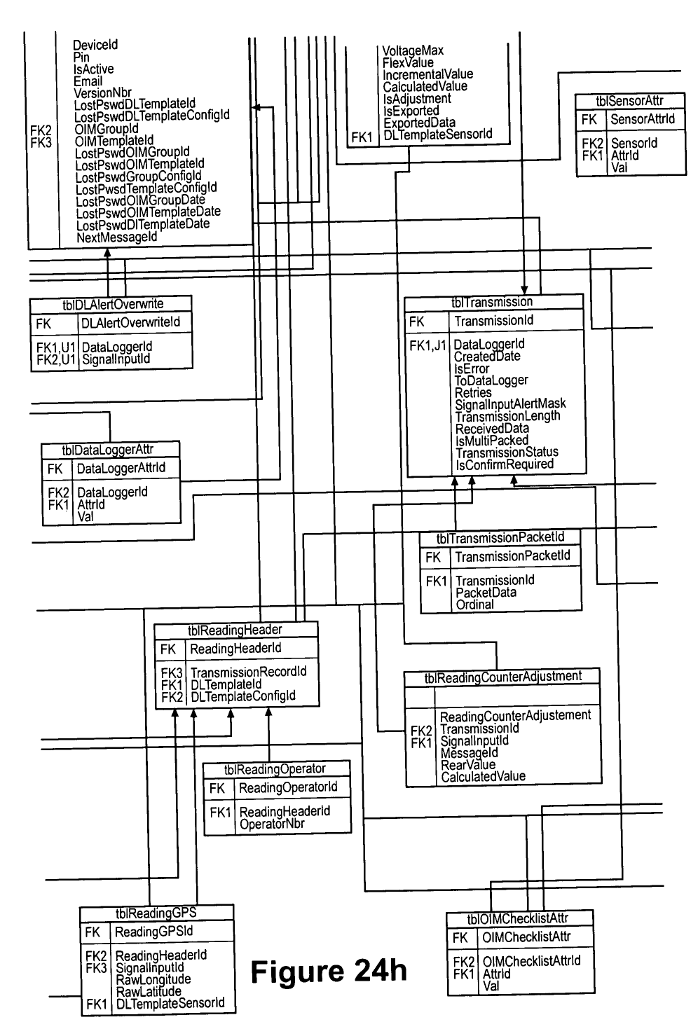

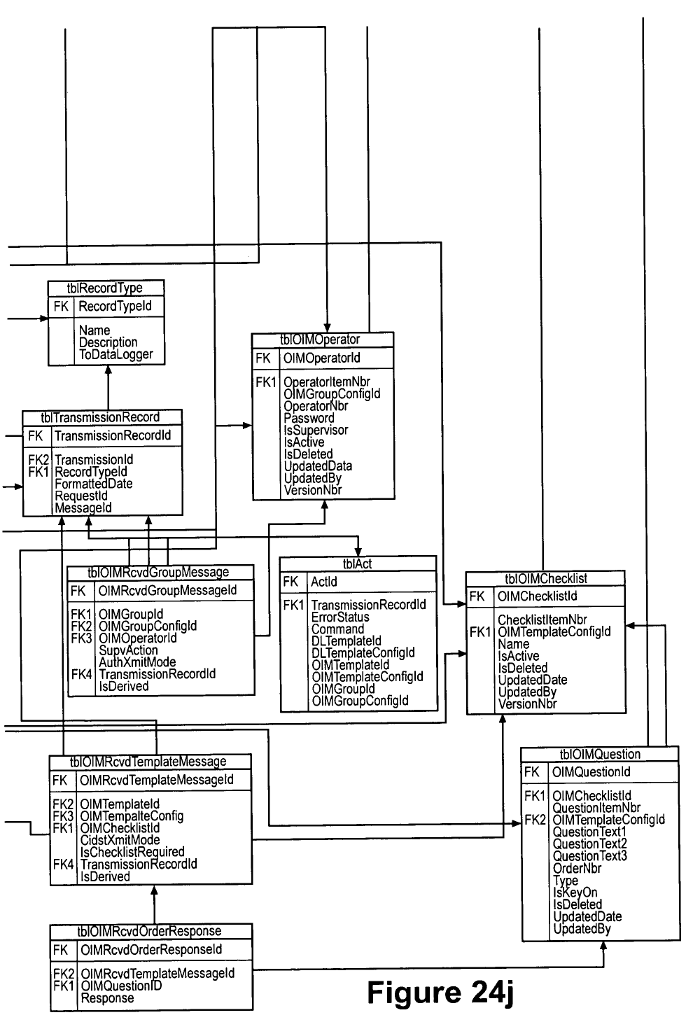

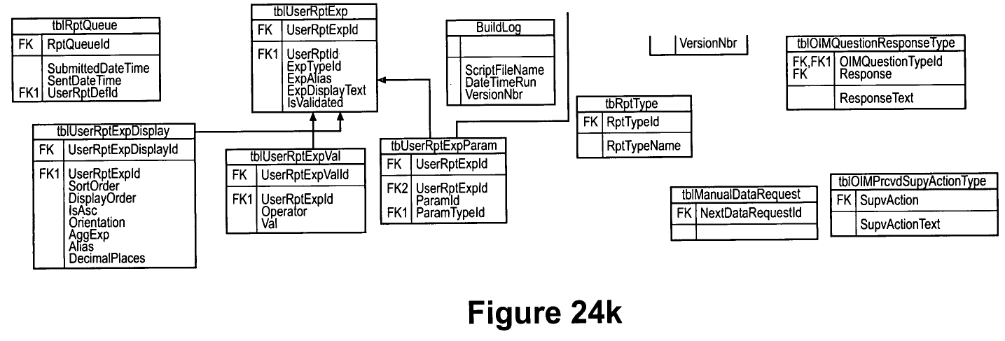

The physical database structure (as illustrated in FIG. 24 discussed below) provides users 102 with the ability to modify the data design 113 implemented by the system 100 without changing any information relating to a database table or column. Thus, the data design 113 is very flexible and totally user-defined. Although the users define the fields and tables dynamically, without modifying the data structure disclosed in FIG. 24. The system 100 can provide the ability to search within the fields and tables that users 102 (without database expertise) create. Through the use of a GUI interface to the user-defined fields and tables very complex queries can be built to deliver very detailed reports. Users also are able to extract data from the database based on self-defined criteria which allows them to view and sort only the fields that are relevant to them. FIGS. 18-21 provide examples of screens that can be used to provide query builder functionality.

Flexible reporting

Multiple formats

Custom filters (on screen viewing & exporting)

Customizable static reports

like the current PDF reports but with many more user selection options

Each customer will be able to select from a list of available fields to include in the report

OLAP reports

Users may save multiple report templates of each type

Large reports may be queued for delivery via email

Custom defined alerts based on user-defined filter criteria—distributed via email

Non-Entity Based Reports:

Entity & Transaction Based Reports:

The Report Management is where users will go to export and view consolidated information about the different management areas within the AIM Application. Users will be able to extract data from the database based on criteria that they set up, and will be able to view and sort based on the fields that are relevant to them.

The List Reports are based on the Search tabs within each of the Management Areas. Each area within AIM that has a Search Tab will be represented within List Reports. The List Reports area of Report Management will display and allow users to create lists of information from the database.

Navigation

The user will access this page from the Navigation Menu.

Page Mode

Browse: If a user only has View access to List Reports, s/he will see all of the reports that s/he has available for running. The Detail tab will display all of the settings for the report, however, it will not allow the user to make any modifications to the report

Modify: If the user Update has access to List Reports, s/he will enter it in Modify mode. The settings for the saved report will display, and the user will be able to make changes to his/her own reports, whether they are public or private. Public reports that the user did not originate will appear in Browse mode.

Page Entry

Report Management

When the page is displayed, the screen is divided into two distinct areas. On the lefts side of the screen, users will see a tree. The tree view will display each of the List Report Types, and all of the reports that a user has access to, regardless if they are public or private. A tabbed pane (which will serve for providing the user with more information about the report selected within the tree view) will appear on the right ⅔rds of the screen. Selecting an item in the tree view will display the details for that item within the tabbed pane.

Upon Entry to the Report Management Area, the “List Reports” root node is selected in the tree, and Search is the first tab, and fronted. Remaining tabs will appear in the following order: Detail, Expression Builder, and Results. All buttons will be disabled until a report or report area is selected.

Report Detail Tab New

When the user clicks the Add button, the Detail Tab will clear all fields.

Report Detail Tab

Upon entering the Detail Tab for an existing report, the detail page will display with the Search Criteria fields and View definition fields filled in.

Report Detail Tab Read-Only

Upon entering the Detail Tab for an existing report, the detail page will display with the data filled in. The report may display in read-only mode if the selected report is a public report that the user did not create.

Data Fields

Required Fields

Name

The Name of the Report. This is not a unique field.

Optional Fields

Controls

Reports Tree View Control

The tree view displays all of the reports, divided into each of the different report categories:

Application Configuration—Attributes

Application Configuration—Currency/Unit of Measure

Application Configuration—Make Model

Application Configuration—Sections

Application Configuration—Templates

Entity Management—Assets

Entity Management—Organizational Entity

Entity Management—Readings

Transaction Management—Transactions

Transaction Management—Transaction Details

Transaction Management—Transaction Header

Security Management—Functional Roles

Security Management—User Groups

Security Management—Users

System Integration

Listed under each report area will be all of the reports that a user has access to. Reports that a user will see within their tree view will be a combination of public and private reports.

Public Checkbox

Checking the Public checkbox on a report allows the user to share the report with the rest of the users within the system who have access to Report Management. If the Public checkbox is not selected, the report will only be viewable by the user who created it.

The Public checkbox will be visible for all reports. A user will be able to check the Public checkbox if s/he has been given the access to create public reports within their Functional Role for their User Group. The Public checkbox will be visible, but not enabled for public reports that s/he has not originated, or if s/he does not have the security ability to create public reports. The public checkbox will always be enabled if the user has the Public Administrator security function within his/her Functional Role.

Criteria List Display—Criteria

The Criteria List Display will display the list of criteria that the user has chosen to locate the destination object (Transaction, Asset, Template, etc.). All entries will be ‘anded’ together (as opposed to an “or” statement). When clicking one word of a statement, the entire criteria statement should be selected, and the parts of the statement are reflected in the Attribute and Condition pick lists, and the value text box.

Attribute Pick List—Criteria

The Attribute Pick List serves as a way of setting comparison values. The Attribute pick list will fill with generic descriptors of data found within the database.

Attributes preceded by a (*) are functions that the user has created through the Expression Builder for this report.

The pick list will be disabled if the report is a public report not originated by the user, if the user does not have the Public Administrator security function within his/her Functional Role.

Condition Pick List—Criteria

The Condition Pick List will contain the conditions that are relevant to the data type of the selected attribute in the Attribute Pick List disclosed in Table L.

| String | Date | Number | Check Boxes |
|---|---|---|---|
| Equals | Today | Equals | Enabled (is |
| | | | checked) |
| Greater Than | Last Month | Greater Than | Disabled (is not |
| | | | checked) |
| Less Than | This Month | Less Than | |
| Greater Than or | Equals | Greater Than or | |
| Equals | | Equals | |
| Less Than or | Greater Than | Less Than or | |
| Equals | | Equals | |
| Not Equal To | Less Than | Not Equal To | |
| Starts With | Greater Than or | | |
| | Equals | | |
| Ends With | Less Than or | | |
| | Equals | | |
| | Not Equal To | | |

The pick list will be disabled if the report is a public report not originated by the user, if the user does not have the Public Administrator security function within his/her Functional Role.

Value Text Box—Criteria

The Value Text Box will hold the value that the data in the database will be evaluated against in conjunction with the Condition Pick List value.

### EXAMPLE

If I want to find all of the Transactions where the Vendor was Acme, and the Job Date was Apr. 15, 2002, I will create the following statements identified in Table M within the ‘Transaction Management—Transaction’ report area:

| | Statement 1 | Statement 2 |
|---|---|---|
| Attribute | Vendor Name | Trans Job Date |
| Condition | Contains | Equals |
| Value | Acme | Apr. 15, 2002 |

Creating these two statements and adding them to the Criteria List Display will find all of the Transactions within the system whose Vendor Name contains Acme & their Job Date was Apr. 15, 2002.

The text box will be disabled if the report is a public report not originated by the user, if the user does not have the Public Administrator security function within his/her Functional Role.

Apply Button—Criteria

The Apply button will select the values from the Attribute Pick List, Condition Pick List, and the Value Text Box, will place the data in the Criteria List Display and re-initialize the fields—ready for a new set of criteria.

Remove Button—Criteria

The Remove button allows the user to remove the selected criteria set from the Criteria List Display. The Remove button will be disabled until a criteria set is selected.

View List Display—Results Presentation

The View List Display will display the list of columns top down as the user has chosen to display them left to right. In addition to the list of results display columns, the View List Display will also indicate if the columns have a sort applied to them, what order in which the columns are sorted, and if there will be any aggregate functions present in the selected column.

Attribute Pick List—Results Presentation

The Attribute Pick List serves as a way of setting comparison values. The Attribute pick list will fill with generic descriptors of data found within the database. The attributes for each of the report areas are documented within each of the Search Functional Description Documents:

Attributes preceded with a (*) are functions that the user has created through the Expression Builder for this report. (For more information see FD-1037 Report Management—Expression Builder.doc)

The pick list will be disabled if the report is a public report not originated by the user, if the user does not have the Public Administrator security function within his/her Functional Role.

Sort Order Pick List—Results Presentation

The Sort Order pick list works in conjunction with the Attribute pick list. Within the result set, the user has the opportunity to select how s/he would like the results sorted. This pick list is required when a Sort Type has been defined for the column.

The Sort Order pick list holds numeric values. The values will always be 1 more than there are columns defined within the View List Display. The pick list will be disabled if the report is a public report not originated by the user, if the user does not have the Public Administrator security function within his/her Functional Role.

Selecting a number that is already in use by another column already defined, the current item will receive that numbered sort, and all columns already added to the View List Display with the same number and greater will shift 1 number larger.

### EXAMPLE

The fields in Table N are defined for the Transaction report:

| | | | Aggregate |
|---|---|---|---|
| Attribute | Sort Order | Sort Type | Function |
| Header Reference # | 1 | Descending | Group |
| Transaction Entity | 2 | Ascending | Group |
| Name | | | |
| Transaction | 3 | Ascending | Sum |
| Amount | | | |
| Transaction Job | | | Group |
| Date | | | |

If a Vendor Name is added to the List with a Sort Type of Ascending, and a Sort Order of 2, the View Display List will adjust as disclosed in Table O:

| | | | Aggregate |
|---|---|---|---|
| Attribute | Sort Order | Sort Type | Function |
| Header Reference # | 1 | Descending | Group |
| Transaction Entity | 3 | Ascending | Group |
| Name | | | |
| Transaction | 4 | Ascending | Sum |
| Amount | | | |
| Transaction Job | | | Group |
| Date | | | |
| Vendor Name | 2 | Ascending | Count |

Sort Type pick list—Results Presentation

The Sort Type pick list will contain two (2) items: Ascending, and Descending. The Sort Type pick list allows the user to specify how the results of their search will be displayed. This pick list is required when specifying a sort order.

The pick list will be disabled if the report is a public report not originated by the user, if the user does not have the Public Administrator security function within his/her Functional Role.

Aggregate Function pick list—Results Presentation

The Aggregate Function pick list will contain available functions based on the data type of the Attribute pick list—View as disclosed in Table P.

| String | Date | Number | Check Boxes |
|---|---|---|---|
| Group | Group | Group | Group |
| Count | Count | Average | Count |
| Max | Max | Count | |
| Min | Min | Max | |
| | | Min | |
| | | Sum | |

Selecting an aggregate function for a report results column determines how the results are calculated for display purposes.

Group—Once an Aggregate function has been set for one column within the report results, all other columns will by default be set for Group. The Group Aggregate function will give a single result set for the like grouped items. It groups all records into a single record set that are the same results for the displayed columns.

Average—The average is exactly or approximately the quotient obtained by dividing the sum total of a set of figures by the number of figures. In statistical terminology, it is the mean value. The Average aggregate function is only available for Number and Decimal data type fields.

Count—The total number of records within the group. Available for all data types.

Max—This function will pull out the largest value within a group of items. For Dates, it will result in the latest of the possible dates (most recent, or furthest in the future), for strings, it will result in the order of the ANSI character set (descending alphabetical order).

Min—This function will pull out the smallest value within a group of items. For Dates, it will result in the earliest of the possible dates (furthest in the past), for strings, it will result in the order of the ANSI character set (ascending alphabetical order).

Sum—The addition of all items within the group. Available for Number type fields only.

Standard Deviation—Estimates standard deviation based on a sample. The standard deviation is a measure of how widely values are dispersed from the average value (the mean).

Variance—Estimates variance based on a sample.

### EXAMPLE

Lets say that I am running a Transaction Report off of the following data in Table Q:

| | Transaction | Transaction | Vendor |
|---|---|---|---|
| Reference # | Entity Name | Amount | Name |
| 123-001 | Sales Department | 400.51 | Acme |
| 123-001 | toy-123-00 | 95.65 | Acme |
| 123-001 | toy-123-11 | 75.00 | Acme |
| 123-002 | eal-00-001 | 80.36 | Acme |
| 123-002 | toy-123-10 | 24.62 | Acme |
| RR-002-1 | Corporate Office | 65.21 | ABC Inc |
| RR-002-1 | eal-00-002 | 35.65 | ABC Inc |
| RR-002-1 | toy-122-01 | 78.01 | ABC Inc |
| RR-002-1 | toy-123-01 | 500.68 | ABC Inc |
| JT-001 | eal-00-001 | 80.65 | Joe's |
| | | | Tune-up |
| 123-003 | Sales Department | 100.25 | Acme |
| 123-003 | eal-00-001 | 900.65 | Acme |
| 123-003 | toy-123-00 | 65.65 | Acme |
| 123-003 | toy-123-10 | 83.64 | Acme |
| 123-003 | toy-123-11 | 81.63 | Acme |

Although all of the records within the original list are unique, what makes them unique is the combination of the Entity Name and the Reference Number. If I want to see a roll-up of all of the costs per vendor separated out by the entity name, I will place the aggregate function of Sum on the Transaction Amount, and the View List Display will look like the list disclosed in Table R:

| | | | Aggregate |
|---|---|---|---|
| Attribute | Sort Order | Sort Type | Function |
| Transaction Entity | 1 | Ascending | Group |
| Name | | | |
| Transaction | | Ascending | Sum |
| Amount | | | |
| Vendor Name | 2 | Ascending | Group |

By dropping the Transaction Header Reference Number from my report results, the report will be generated, and all of the records that are the same will be combined, and their Transaction Totals, summed as disclosed in Table S:

| Transaction | Transaction | |
|---|---|---|
| Entity Name | Amount | Vendor Name |
| Corporate Office | 65.21 | ABC Inc |
| eal-00-001 | 981.01 | Acme |
| eal-00-001 | 80.65 | Joe's Tune-up |
| eal-00-002 | 35.65 | ABC Inc |
| Sales Department | 500.76 | Acme |
| toy-122-01 | 78.01 | ABC Inc |
| toy-123-00 | 161.30 | Acme |
| toy-123-01 | 500.68 | ABC Inc |
| toy-123-10 | 108.26 | Acme |
| toy-123-11 | 156.63 | Acme |

View Order Up/Down Buttons—Results Presentation

The View Move Up/Down buttons are positioned to the right of the View List Display Box. They are used to adjust the order of the column display left to right as they appear in the View List Display Box top down.

When an item is selected within the View List Display Box, clicking the order up button will move the selected item up once for each time the button has been clicked. Once the selected item is at the top of the list box, clicking the order up button will not perform any additional action.

Clicking the order down button will move the selected item down once for each time the button has been clicked. Once the selected item is at the last in the list box, clicking the down button will not perform any additional action.

The ordering buttons will be disabled if the report is a public report not originated by the user, if the user does not have the Public Administrator security function within his/her Functional Role.

Apply Button—Results Presentation

The Apply button will select the values from the Attribute, Sort Order, and Sort Type Pick Lists, and will place the data in the View Display List, and re-initialize the Attribute, Sort Order, and Sort Type fields—ready for a new set of criteria.

Remove Button—Results Presentation

The Remove button allows the user to remove the selected criteria set from the View List Display. The Remove button will be disabled until a criteria set is selected.

Add

Clicking the Add button will initialize the Detail Tab & clear out all fields. The attributes that will fill the Attribute pick lists will be dependent on the management area that was selected prior to clicking the add button.

The Add button will be disabled when the “List Reports” root node is selected. If the user selects the any management area nodes, or a report, the Add button will be re-enabled. The add button will also be disabled if the report is a public report not originated by the user, if the user does not have the Public Administrator security function, or Update Report within his/her Functional Role.

Replicate

Clicking the Replicate button while a report is selected will copy the report, and clear out the name. The Report Name will need to be filled in prior to saving. Replicating a public report is allowed. The copy will be private.

The Replicate button will be disabled when the “List Reports” root node or any of the management area nodes are selected. If the user selects a report, the Replicate button will be re-enabled. The replicate button will also be disabled if the report is a public report not originated by the user, if the user does not have the Public Administrator, or Update Report security function within his/her Functional Role.

Delete

Clicking Delete while a report is selected will delete the report. Delete will not be enabled if the “List Reports” root node, or if a management area is selected.

The Delete button will only be disabled when the “List Reports” root node or any of the management area nodes are selected. If the user selects a report, the Delete button will be re-enabled. The delete button will be disabled if the report is a public report not originated by the user, if the user does not have the Public Administrator security function, or Update Report within his/her Functional Role.

Export Format Pick List

The Export Format pick list specifies what the resulting file format will be when the report is exported. The Export Format pick list will contain 2 values: Extensible Markup Language (XML), and Tab Delimited Format.

Export Button

Export Button allows the user to start the search of the database with the search criteria that they have populated within the Criteria List Display, and export the results of the report as defined by the Export Format pick list. Clicking the Export Button will post the Windows Standard “Save As” window, allowing the user to control the placement and name of their exported report.

Run Report Button

Clicking the Run Report Button will allow the user to start the search of the database with the search criteria that they have populated within the Criteria List Display. The Run Report Button will display the Results tab with the results of the report filled in.

Save

The Save button will allow the user to save all of the changes that the user has made to the entire transaction header (what is viewable in the tree view) to the database. The save button will be disabled if the report is a public report not originated by the user, if the user does not have the Public Administrator, or Update Report security function within his/her Functional Role.

Cancel

Clicking the Cancel button will revert back any changes that have been made to the report to what it was when it was last saved. If the report is new, and the Save button has not yet been clicked, the cancel button will cancel the addition of the record to memory, and the database.

Business Logic

Only the user who created a public report can edit that report.

Transaction Reports: A user may get additional results than if the user ran the same query within the Search functionality of Transaction Management because: within Transaction management, the user must have data access to all entities that a transaction header is associated with in order to view that Transaction Header within Transaction Management. Because the entire Transaction Header does not have to be retrieved to appear on a report, if only parts of the Transaction Header are still within the user's data access, the data will show up on a report.

Entity & Transaction Management Reports: Unless dates are specified, all reports are run as of the current date.

A user who has access to public reports, however does not have the security to create public reports may replicate a public report. In this event, the user will become the originator, and the report will become private

If an originator of a public report gets deleted (future functionality) the report should get deleted. Prior to deleting the user, the administrator can duplicate the report, and then become the owner.

Security Requirements:

Users will see only their own private reports.

Reports will be additionally filtered by the user's data access

The management areas that the user has listed within the tree are only those management areas that the user has at least view access to.

It will be a security role for the user to be able to create & edit public reports.

If a user has view access to List Reports, s/he will have access to view public reports.

There will be an additional security access for a user to edit other's public reports.

An example of Audit Trail information is disclosed in Table T:

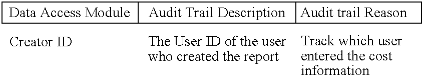

The reports audit trail isn't an audit trail in the same way as the Entity & Transaction audit trails. The audit trail here really only captures the creator of the report for two purposes:

To determine which reports are available to a user (all user created & public reports)

To determine who can edit a public report (only the creator and Public Administrator)

Messages are disclosed in Table U:

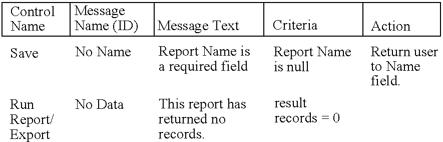

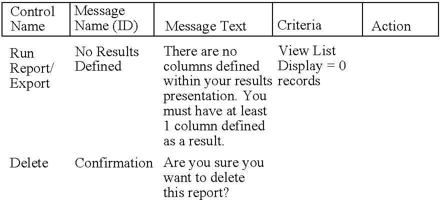

Page Name: Report Management—Expression Builder

The Report Management is where users will go to export and view consolidated information about the different management areas within the AIM Application. Users will be able to extract data from the database based on criteria that they set up, and will be able to view and sort based on the fields that are relevant to them.

The List Reports are based on the Search tabs within each of the Management Areas. Each area within AIM that has a Search Tab will be represented within List Reports. The List Reports area of Report Management will display and allow users to create lists of information from the database.

The Expression Builder tab within the List Reports allows a user to build very basic formulas, or calculations, and store them as attributes accessible for use as criteria statements or viewing and sorting columns within the report result set. Expressions will display in the Attribute pick lists on the Detail tab with an asterisk (*) preceding the expression name.

Navigation

The user will access this page from the Navigation Menu.

Page Mode

Modify: Like all of the other AIM Management areas, if the user has access to Reports Management, s/he will enter it in read/write mode.

Page Entry

Report Management

When the page is displayed, the screen is divided into two distinct areas. On the lefts side of the screen, users will see a tree. The tree view will display each of the List Report Types, and all of the reports that a user has access to, regardless if they are public or private. A tabbed pane (which will serve for providing the user with more information about the report selected within the tree view) will appear on the right ⅔rds of the screen. Selecting an item in the tree view will display the details for that item within the tabbed pane.

Upon Entry to the Report Management Area, the “List Reports” root node is selected in the tree, and Detail is the first tab, and fronted. Because the “List Reports” node is the selected node upon page entry, the controls on the Detail tab will be disabled. Remaining Tabs will appear in the following order: Expression Builder, and Results. All buttons will be disabled until a report or report area is selected.

Expression Builder Tab

Upon entering the Expression Builder Tab for an existing report, the Expression List will list all of the expressions that have been defined for this report. None of the Expressions will be selected.

Data Fields

Required Fields

Name

The Name of the Expression. This is a unique field per report.

Optional Fields

none

Controls

Reports Tree View Control

The tree view displays all of the reports, divided into each of the different report categories:

Application Configuration—Attributes

Application Configuration—Currency/Unit of Measure

Application Configuration—Make Model

Application Configuration—Sections

Application Configuration—Templates

Entity Management—Assets

Entity Management—Organizational Entity

Entity Management—Readings

Transaction Management—Transactions

Transaction Management—Transaction Details

Transaction Management—Transaction Header

Security Management—Functional Roles

Security Management—User Groups

Security Management—Users

System Integration

Listed under each report area will be all of the reports that a user has access to. Reports that a user will see within their tree view will be a combination of public and private reports.

Expression List

The Expression List will list all of the expressions that have been created for, and are available to the selected report.

Expression Text text box

Upon selecting an expression from the Expression List will display the text of that expression within the Expression Text text box.

The Expression Text text box is editable by clicking in the text box & editing as one would edit text. No validation will be performed as the user is editing the expression. Valid characters and arguments for the expression text are:

Numbers 0-9

+, −, *, /, (, )

Valid Attributes for this type of report

Users may type directly into the Expression Text field to create the calculation, use his/her[Backspace] and[Delete] keys to delete unwanted characters and symbols within their expression. Other keystrokes that will be available for the user to use are[Ctrl+C] (copy), and[Ctrl+V] (paste), to re-arrange the arguments within their expression.

Attribute Pick List

The attribute pick list will contain all of the number type attributes available for the associated report area. Selecting an attribute within the pick list will place the attribute at the cursor position within the ‘Expression Text’ text box. Attributes will appear with brackets ([ ]) around them once they are placed in the ‘Expression Text’ text box.

+ Button

Clicking the +button will place a plus sign (+) at the cursor position within the ‘Expression Text’ text box.

Button

Clicking the—button will place a minus sign (−) at the cursor position within the ‘Expression Text’ text box.

/ Button

Clicking the / button will place a division symbol (/) at the cursor position within the ‘Expression Text’ text box.

Button

Clicking the * button will place an asterisk (*) at the cursor position within the ‘Expression Text’ text box.

( Button

Clicking the ( button will place an open parenthesis at the cursor position within the ‘Expression Text’ text box.

) Button

Clicking the ) button will place a closed parenthesis at the cursor position within the ‘Expression Text’ text box.

Apply Button

Clicking the Apply button will either add the expression to the Expression List, or update the expression in the Expression List if any changes have been made.

Some basic validation will be performed on the expression upon clicking apply;
Repeated operators

Invalid characters (a-z, other invalid operators)

Matching parenthesis

Confusing operations (example[List Price]−+[Original Equipment Cost])

Remove Button

Clicking the Remove button will remove the selected expression from the report.

(See Messages Section Below)

Add

Clicking the Add button will initialize the Detail Tab & clear out all fields. The attributes that will fill the Attribute pick lists will be dependent on the management area that was selected prior to clicking the add button.

The Add button will only be disabled when the “List Reports” root node is selected. If the user selects the any management area nodes, or a report, the Add button will be re-enabled.

Replicate

Clicking the Replicate button while a report is selected will copy the report, and clear out the name. The Report Name will need to be filled in prior to saving. Replicating a public report is allowed. The copy will be private.

The Replicate button will only be disabled when the “List Reports” root node or any of the management area nodes are selected. If the user selects a report, the Replicate button will be re-enabled.

Delete

Clicking Delete while a report is selected will delete the report. Delete will not be enabled if the “List Reports” root node, or if a management area is selected.

The Delete button will only be disabled when the “List Reports” root node or any of the management area nodes are selected. If the user selects a report, the Delete button will be re-enabled.

Export Format Pick List

The Export Format pick list specifies what the resulting file format will be when the report is exported. The Export Format pick list will contain 2 values: Extensible Markup Language (XML), and Comma Separated Value (CSV).

Export Button

Export Button allows the user to start the search of the database with the search criteria that they have populated within the Criteria List Display, and export the results of the report as defined by the Export Format pick list. Clicking the Export Button will post the Windows Standard “Save As” window, allowing the user to control the placement and name of his/her exported report.

Run Report Button

Clicking the Run Report Button will allow the user to start the search of the database with the search criteria that they have populated within the Criteria List Display. The Run Report Button will display the Results tab with the results of the report filled in.

Save

The Save button will allow the user to save all of the changes that the user has made to the entire transaction header (what is viewable in the tree view) to the database.

Cancel

Clicking the Cancel button will revert back any changes that have been made to the report to its definition when it was last saved. If the report is new, and the Save button has not yet been clicked, the cancel button will cancel the addition of the record to memory, and the database.

Business Logic

Expressions are only associated with the report that they have been created under.

The expression needs to make some sense.

Security Requirements:

If a user has access to create or edit a report, s/he has access to create expressions within the expression builder.

Audit Trail:

There is no audit trail for the Expression Builder.

Messages in Table V:

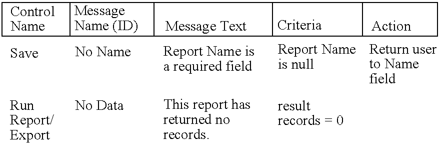

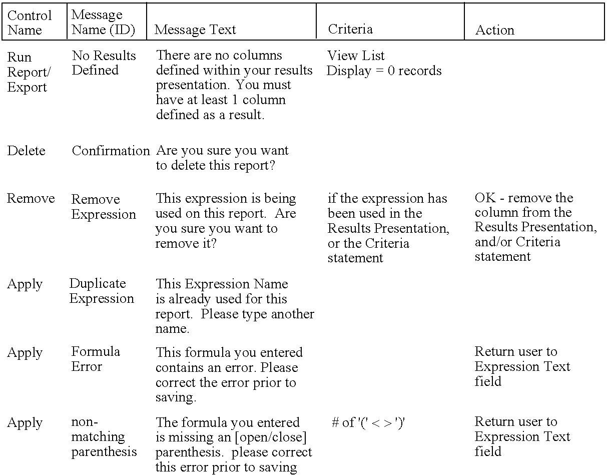

Page Name: List Reports—Summary

The Report Management is where users will go to export and view consolidated information about the different management areas within the AIM Application. Users will be able to extract data from the database based on criteria that they set up, and will be able to view and sort based on the fields that are relevant to them.

The List Reports are based on the Search tabs within each of the Management Areas. Each area within AIM that has a Search Tab will be represented within List Reports. The List Reports area of Report Management will display and allow users to create lists of information from the database.

The Summary page will mainly be used for public reports where the user running the report is not the user who created the report. Because a user is unable to modify any of the report set-up, the Summary tab allows for an understated interface to the report parameters that are editable for a public report.

Navigation

The user will access this page from the Navigation Menu.

Page Mode

Modify: This page will always be in Modify Mode. If a user has access to a public report, this will be the screen that they will be able to modify the Summary tab.

Page Entry

Report Management

When the page is displayed, the screen is divided into two distinct areas. On the lefts side of the screen, users will see a tree. The tree view will display each of the List Report Types, and all of the reports that a user has access to, regardless if they are public or private. A tabbed pane (which will serve for providing the user with more information about the report selected within the tree view) will appear on the right ⅔rds of the screen. Selecting an item in the tree view will display the details for that item within the tabbed pane.

Upon Entry to the Report Management Area, the “List Reports” root node is selected in the tree, and Search is the first tab, and fronted. Remaining tabs will appear in the following order: Summary, Detail, Expression Builder, and Results. All buttons will be disabled until a report or report area is selected.

Report Summary Tab New

Since a user cannot re-save their settings to a public report, the Summary tab will always appear in a “new” state.

Data Fields

Optional Fields

Begin Date

The Begin Date represents the beginning date of the report. Depending on the category of report that the user is creating, this date will be evaluating different dates within the database

Transaction Header:

The Begin Date for Transaction Header Reports will evaluate the Transaction Header Date, and return all transactions headers where the Transaction Header Date is greater than or equal to the Begin Date

Transaction:

The Begin Date for Transaction Reports will evaluate the Transaction Date, and return all transactions where the Transaction Date is greater than or equal to the Begin Date

Transaction Detail:

The Begin Date for Transaction Detail Reports will evaluate the Transaction Detail's parent Transaction Date, and return all transaction details where the Transaction Date is greater than or equal to the Begin Date

Asset Entity:

The Begin Date for Asset Entity Reports will evaluate the History records for each of the assets within the system. Running the report will return all assets where the last history record end date is greater than or equal to the Begin Date

Logic:

The dividing line for 2-digit interpretation should be 1950. Meaning that if someone types in 01-01-51, the year should default to 1951. If a user types 101048, the year should default to 2048.

If a user intends to type 1932, they must type the 4 digits.

Acceptable Formats:
010102
1/01/02
1/1/02
01-01-02
1-1-02
1102 (the last two digits would always be the year, depending on how many digits are left would determine the month & day (if left with 3, I think it is safe to assume that the first digit is the month & second 2 are the date)

End Date

The End Date represents the ending date of the report. Depending on the report that the user is creating, this date will be evaluating different dates within the database. The end date will pre-fill with the current date. This field is required.

Transaction Header:

The End Date for Transaction Header Reports will evaluate the Transaction Header Date, and return all transactions headers where the Transaction Header Date is less than or equal to the End Date

Transaction:

The End Date for Transaction Reports will evaluate the Transaction Date, and return all transactions where the Transaction Date is less than or equal to the End Date

Transaction Detail:

The End Date for Transaction Detail Reports will evaluate the Transaction Detail's parent Transaction Date, and return all transaction details where the Transaction Date is greater than or equal to the End Date

Asset Entity:

The End Date for Asset Entity Reports will evaluate the History records for each of the assets within the system. Running the report will return all assets where the first history record start date (aka: In Service Date) is less than or equal to the End Date.

Controls

Report Hierarchy Timeline

The Report Hierarchy Timeline allows the user to specify what data is retrieved when running a report. The parameters entered are Organizational structure, Asset structure, and Asset history. In order to determine which Report Timeline the user will select, the user will ask him/herself a few questions:

Organization Hierarchy

Do I want to see all of the different parent's that my org entities have belonged to?

Or do I want to see the org entities in their locations as one point in time?

Asset Hierarchy

Do I want to see all of the different parent's that my assets have belonged to?

Or do I want to see the assets in their locations as one point in time?

History

Do I want to see the complete history1 of the asset? 1 History refers to all of the transactions, and readings associated with the asset or organizational entity.
1 History refers to all of the transactions, and readings associated with the asset or organizational entity.

Or do I only want to see the history of the asset when the asset was with its parent?

Org Hierarchy: Asset Hierarchy: History

The items within the Org Hierarchy: Asset Hierarchy: History pick list will produce the report scenarios based on the questions asked above.

Static: Viewing the hierarchy in a static mode will display the org hierarchy or asset hierarchy as they appeared at one point in time. (similar to the Entity Management tree view control)

Dynamic: Viewing the hierarchy in a dynamic mode will display the org hierarchy or asset hierarchy as they have ever appeared within the company. The viewer may see the same organization or asset twice because of movement within the company.

Static: Static: Unlimited

This report is an excellent selection for viewing the complete maintenance history for a particular asset, or facility. The organization's hierarchy is static as of the Activity Date, and the assets are also where they appeared on that date. All history for assets and organizations are retrieved. There is no security as entities are moved through out the organization.

So, even though an asset has only been within my data access for 3 weeks, I will be able to see the entire maintenance history for its lifetime within the application.

A user will have access to this report perspective if it has been granted in the user's Functional Role.

Static: Dynamic: Hierarchy

This report will show asset movement within the organization. The organization's hierarchy is static as of the Activity Date, however the assets will be dynamic; an asset may show up twice in a report because it may have moved from one location to another. The history records that are retrieved are the history as the asset has resided with its parent.

A user will have access to this report perspective if it has been granted in the user's Functional Role.

Static: Static: Hierarchy

This report is an excellent selection for viewing the complete maintenance history for a particular asset, or facility as it has resided within an organization. The organization's hierarchy is static as of the Activity Date, and the assets are also where they appeared on that Activity Date. The history records that are retrieved are the history as the asset has resided with its parent.

The difference between this report and the first report (Static: Static: Unlimited) is that the first report will display the entire history of the items, whereas here, the only history retrieved is for the time that the entity has been the history dependent is on its life at its parent.

A user will have access to this report perspective if it has been granted in the user's Functional Role.

Dynamic: Dynamic: Hierarchy

This report shows all entities that have ever been associated with a parent entity. The report will pull all the organizational entities that have ever been associated with one specific organizational entity (determined by Data Access, or Criteria statements for the activity date. The history records that are retrieved are the history as the asset has resided with its parent.

A user will have access to this report perspective if it has been granted in the user's Functional Role.

Entity Picker & Display Field

By default the entity picker text field will be populated with the user's top-level data access. They may select a different entity to run the report off of by selecting the entity picker to choose a different entity within their data access view. The name of the entity will appear in the corresponding text field.

Business Logic

Since these are duplicate fields from the Detail tab, the data from the fields on the Detail tab will populate with the data that the user entered on that page. The Summary tab will not “force” any changes to the Detail tab.

Security Requirements:

None for this screen.

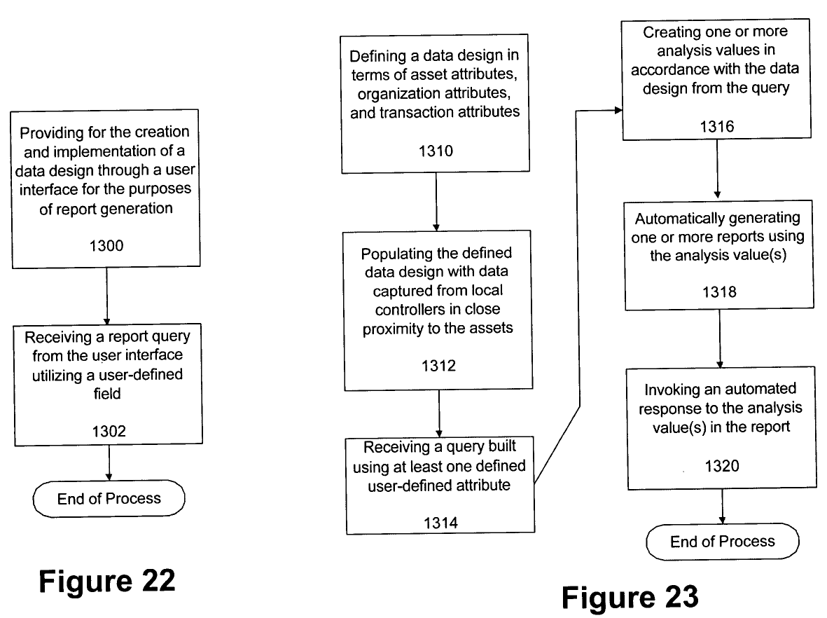

FIGS. 22 and 23 disclose process-level views for the functionality of building queries 106 to generate reports 107.

At 1300, the creation and implementation of a configurable data design is provided through a user interface. At 1302, a query 106 is received to automatically generate a report 107 in accordance with the customized data design 113 as configured by one or more users 102. The process ends, awaiting the submission of additional queries 106 as desired.

FIG. 23 discloses a more detailed process flow view, in which different types of information are included in the query 106. At 1310, a data design 113 is defined in terms of asset attributes, organization attributes, and transaction attributes. At 132. the defined data design is populated with data captured from local controllers in close proximity to the assets. At 1314. a query is built using at least one type of user-defined attribute, and potentially multiple attributes of multiple types. At 1316, one or more analysis values are created in accordance with the data design from the query 106. At 1318, one or more reports are automatically generated. At 1320, one or more responses may be automatically invoked in response to particular analysis values contained in the report 107. The process ends, awaiting the submission of additional queries 106 as desired.

V. Data Design

FIG. 24 is a block diagram illustrating the relationships between FIGS. 24a through 24h. FIGS. 24a through 24h illustrate an example of a physical database table layout that can support the highly configurable data design 113 used by the system 100.

VI. Alternative Embodiments

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope.

1. An analysis system, comprising:
a data device, said data device including a plurality of attribute types in an embodiment of a data design, wherein said data device provides for the storage of said attribute records in accordance with said data design;
an application device, said application device including an application incorporating said data design, said application including a configurable template, wherein a modification to said configurable template automatically modifies said data design, and wherein said application provides for generating an analysis from the attribute records in said data device.

2. The system of claim 1, wherein said plurality of attribute types includes a transaction attribute type, an asset attribute type and an organization attribute type, and wherein each attribute type corresponds to a plurality of attribute records.

3. The system of claim 1, further comprising a plurality of assets and a plurality of local controllers, wherein said plurality of local controllers provide for the capturing of information from said plurality of assets, and wherein said information is stored as said attribute records in said data device in accordance with said data design.

4. The system of claim 1, further comprising a plurality of data hierarchies, said plurality of data hierarchies including an organization hierarchy, an asset hierarchy, and a transaction hierarchy.

5. The system of claim 1, wherein said application can modify the number of configurable templates.

6. The system of claim 1, further comprising a web server, wherein said application resides on a web server, and wherein said application provides for interactions with a plurality of users associated with a plurality of organizations in a simultaneous or substantially simultaneous manner.

7. The system of claim 6, wherein access to said application is sold in accordance with an application service provider agreement.

8. The system of claim 6, further comprising a plurality of data designs, wherein each organization accessing said application does so in accordance with said data design associated with said accessing organization.

9. The system of claim 1, further comprising a plurality of configurable business rules, wherein said application provides for generating said analysis in accordance with at least one said business rule.

10. The system of claim 1, wherein said application is an asset management program, and wherein said analysis relates to a cost-benefit analysis of at least one said attribute type.

11. The system of claim 1, wherein said attribute records are populated by a manual data entry process.

12. The system of claim 1, wherein said attribute records are populated by a batch upload process.

13. The system of claim 1, wherein said attribute records are populated by an automated transfer process from a first computer to a second computer.

14. The system of claim 1, wherein said attribute records are populated through a wireless data collection process.

15. The system of claim 1, wherein said attribute records are populated automatically by an interfacing computer program.

16. An asset management system, comprising:
a database, said database including a data design, and a plurality of attributes, said plurality of attributes comprising a plurality of attribute types, and a plurality of attribute values;
wherein said plurality of attribute values are associated with said plurality of attribute types in accordance with said data design;
said plurality of attribute types comprising:
a plurality of asset attributes;
a plurality of organization attributes;
a plurality of transaction attributes;
an asset management application, said application including a plurality of templates, and an asset analysis;
wherein each template in said templates provides for the modification of a subset of said data design;
said plurality of templates including an asset template, an organization template, and a transaction template; and
wherein said application provides for generating said asset analysis from at least one said asset attribute, at least one said organization attribute, and at least one said transaction attribute.

17. The system of claim 16, wherein said plurality of organization attributes include an organization hierarchy, a plurality of roles, and a plurality of business rules, wherein said organization hierarchy comprises a plurality of organization levels, including a first organization level and a second organization level, and wherein each organization level is associated with a subset of said roles and a subset of said business rules.

18. The system of claim 16, wherein said plurality of transaction attributes include a plurality of transaction types comprising at least three of: a lease; a rent; purchase; a sale; a depreciation; an interest payment; an asset management fee; a maintenance contract; a project management; a repair; an abuse; a freight charge; a tax; and a travel cost.

19. The system of claim 16, wherein said plurality of asset attributes includes an accounting characteristic and a physical characteristic.

20. The system of claim 16, wherein said asset analysis is a profitability analysis.

21. The system of claim 16, wherein said asset analysis does not relate to a monetary value.

22. The system of claim 16, wherein said asset analysis is created with an on-line analytical processing-based functionality.

23. The system of claim 16, wherein said application provides for creating additional templates.

24. The system of claim 16, wherein said application provides for creating additional attribute types.

25. The system of claim 16, wherein said application provides for modifying said attribute types.

26. A method for managing assets, comprising:
providing an application supported by an underlying data design;
capturing a plurality of organization attributes through the use of a first configurable template associated with an application;
receiving a plurality of asset attributes through the use of a second configurable template associated with an application;
defining a plurality of transaction attributes through the use of a third configurable template associated with an application;
modifying the data design through the use of at least one configurable template;
generating an analysis from data stored in accordance with the modified data design.

27. The method of claim 26, wherein said first configurable template is also said second configurable template.

28. The method of claim 26, wherein said third configurable template is also said first configurable template and said second configurable template.

29. The method of claim 26, wherein the application is provided by an application service provider for access by multiple organizations in a simultaneous or substantially simultaneous manner.

30. The method of claim 26, further comprising associating a particular transaction type with an accounting procedure.

31. The method of claim 26, further comprising associating a particular business rule with a particular role in an organization.

32. The method of claim 26, further comprising associating the ability to possess assets to a particular sub-unit of an organization.

33. The method of claim 26, further comprising associating a transaction type with an asset type.

34. The method of claim 26, further comprising association an asset attribute, an organization attribute, and a transaction attribute with a business rule.

35. The method of claim 26, further comprising adding a configurable template to said application.
